(19) United States
(12) Patent Application Publication
(10) Pub. No.: US 2002/0114015 A1
(43) Pub. Date: Aug. 22, 2002

(54) Apparatus and method for controlling optical system

(76) Inventors: Shinichi Fujii, Osaka-Shi (JP); Yasuhiro Morimoto, Takatsuki-shi (JP); Keiji Tamai, Suita-shi (JP); Masataka Hamada, Osakasayama-shi (JP); Naotaka Kishida, Sakai-Shi (JP); Kazuhiko Yukawa, Sakai-shi (JP); Kazumi Yukawa, Sakai-shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/020,051

(22) Filed: Dec. 14, 2001

(30) Foreign Application Priority Data
Dec. 21, 2000 (JP) 2000-388822

(51) Int. Cl. H04N 1/21; H04N 1/23

(52) U.S. Cl. 358/302

(57) ABSTRACT

An AF control portion of a digital camera has therein a histogram generating circuit for generating a histogram of widths of edges in an AF area, a noise eliminating portion for eliminating noise components from the histogram, a histogram evaluating portion for calculating an evaluation value indicative of the degree of achieving focus from the histogram, and a contrast calculating circuit for calculating contrast in the AF area. Further, a driving amount determining portion for determining an amount of driving a focusing lens, and a driving direction determining portion for determining a direction of driving the focusing lens are provided. The driving direction determining portion determines the direction of driving the focusing lens by using contrast. The driving amount determining portion positions the focusing lens to an in-focus position promptly with high precision while changing the driving amount by using the evaluation value of the histogram and the contrast.

This application is based on application No. 2000-388822 filed in Japan, the contents of which are hereby incorporated by reference.

### BACKGROUND OF THE INVENTION

1. Field of the Invention

The present invention relates to an autofocus technique at the time of capturing an image.

2. Description of the Background Art

In one of conventional image capturing apparatuses for capturing an image by using an image capturing device such as a CCD (Charge Coupled Device) like a digital camera or a video camera, a technique called a contrast method is applied in order to attain autofocus. The contrast method herein denotes a method of obtaining contrast of an image captured at each driving stage as an evaluation value while driving a focusing lens and determining a lens position at which the highest evaluation value is obtained as an in-focus position.

In another conventional image capturing apparatus, a method of extracting edges from an image and estimating an in-focus position of a focusing lens from a histogram of edge widths (hereinbelow, also called “edge width method”) has been also proposed. By using the principle that an edge width corresponding to the center of gravity of a histogram has a predetermined value when an optical system is in a focused state, in the edge width method, histograms of edge widths corresponding to a plurality of positions of the focusing lens are preliminarily obtained, and an in-focus position of the focusing lens is predicted from the plurality of histograms. The edge width method has a characteristic such that the in-focus position of the focusing lens can be promptly obtained.

In recent years, however, the pixel pitch is becoming finer as the resolution of the image pickup device is becoming higher. As a result, the focusing precision required of a digital still camera is becoming higher. Consequently, when the in-focus position is obtained by moving the focusing lens little by little by using the conventional contrast method, it becomes difficult to attain autofocus promptly and a chance to take a good picture may be missed.

The focus control method according to the edge width method intended to achieve resolution as high as that of a conventional video camera has a problem such that the in-focus position cannot be promptly and accurately obtained.

### SUMMARY OF THE INVENTION

The present invention is directed to an apparatus for controlling an optical system at the time of capturing a still image as digital data.

According to one aspect of the present invention, this apparatus comprises: an instructing part for instructing preparation for capturing an image; a calculator for detecting edges in an image in response to an instruction from the instructing part and calculating an evaluation value indicative of the degree of achieving focus from the edges; and a controller for driving the optical system while changing a driving speed on the basis of the evaluation value.

Since the evaluation value is calculated from the edges and the driving speed is changed on the basis of the evaluation value, control regarding focusing of the optical system can be performed promptly.

In a preferred embodiment of the present invention, the evaluation value is calculated on the basis of histograms of widths of the edges. Thus, a proper evaluation value can be obtained.

In another preferred embodiment of the present invention, the controller compares the evaluation value with a threshold value. After the optical system is driven in accordance with the comparison result, the evaluation value is calculated again. Thus, the optical system is driven promptly until the comparison result changes.

The present invention is also directed to a method of controlling an optical system at the time of capturing a still image as digital data.

The present invention is also directed to a recording medium on which a program for making a control apparatus control an optical system at the time of capturing a still image as digital data is recorded.

Therefore, an object of the present invention is to perform an autofocus control promptly and properly at the time of capturing a still image by using edges extracted from an image.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 to 4 are front views of a digital camera which is a first preferred embodiment;

FIG. 5 is a block diagram showing the configuration of the digital camera;

FIG. 6 is a diagram showing the internal configuration of an image pickup portion;

FIG. 7 is a flowchart schematically showing the operations of the digital camera;

FIG. 8 is a block diagram showing the configuration of an AF control portion;

FIG. 9 is a block diagram showing the functional configuration of the AF control portion;

FIG. 10 is a diagram for explaining a state of edge detection;

FIG. 11 is a block diagram showing the configuration of a histogram generating circuit;

FIGS. 12 to 14 are diagrams showing the flow of generation of a histogram;

FIG. 15 is a diagram showing an AF area;

FIG. 16 is a diagram showing pixel arrangement in the AF area;

FIGS. 17 to 19 are diagrams showing the flow of an AF control in the first preferred embodiment;

FIG. 20 is a diagram showing the flow of calculation of an edge width corresponding to a center of gravity;

FIGS. 21 and 22 are diagrams showing a state where noise components are eliminated from a histogram;

FIG. 23 is a diagram showing the relation between a lens position and the number of edges;

FIGS. 24 and 25 are diagrams showing the flow of an AF control in a second preferred embodiment;

FIG. 26 is a diagram showing the flow of setting of a lens movement amount;

FIG. 27 is a diagram showing a change in a histogram due to a change in lens position;

FIG. 28 is a diagram showing the relation between the lens position and the edge width corresponding to a center of gravity;

FIGS. 29 and 30 are diagrams each showing the flow of an AF control in a third preferred embodiment;

FIG. 31 is a block diagram showing a connecting relation between a histogram evaluating portion and other components in a fourth preferred embodiment;

FIG. 32 is a diagram showing a change in the relation between a spatial frequency and MTF due to a change in an aperture value (f-number);

FIG. 33 is a diagram showing a change in the relation between a spatial frequency and MTF due to a change in a focal distance; and

FIG. 34 is a diagram showing the relation between an aperture value (f-number) and a reference edge width.

### DESCRIPTION OF THE PREFERRED EMBODIMENTS

1. First Preferred Embodiment

1.1 Configuration of Digital Camera

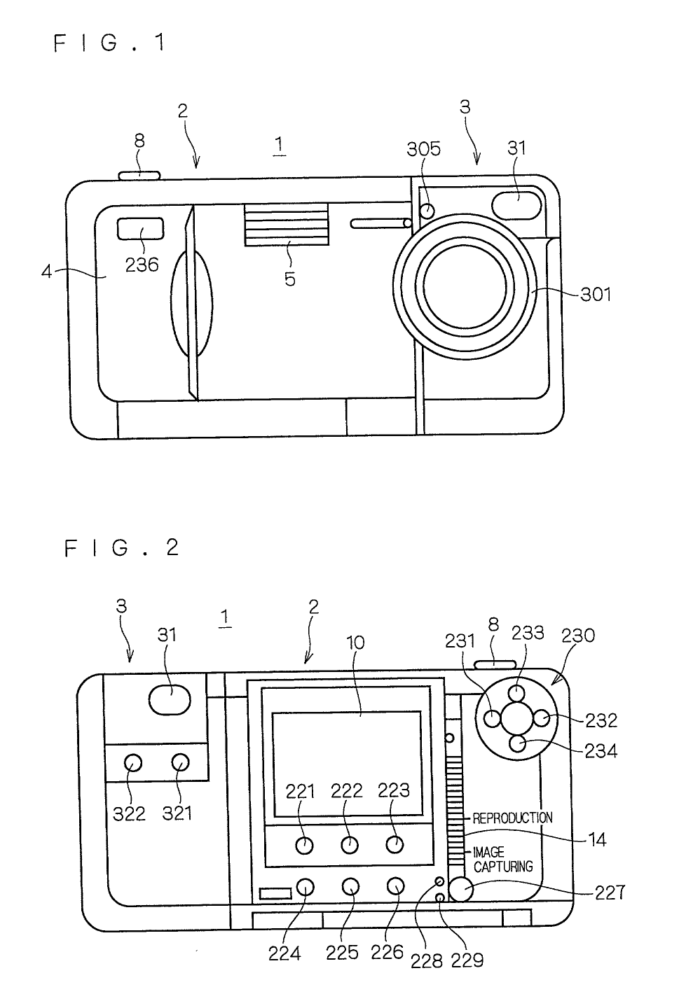

FIGS. 1 to 4 are front view, rear view, side view and bottom view, respectively, showing an example of appearance of a digital still camera (hereinbelow, called a “digital camera”) 1 for capturing a still image as digital data.

The digital camera 1 is constructed by, as shown in FIG. 1, a box-shaped camera body portion 2 and an image pickup portion 3 of an almost rectangular parallelepiped shape.

On the front face side of the image pickup portion 3, a zoom lens 301 as a taking lens is provided. In a manner similar to a conventional camera using a film, a light control sensor 305 for receiving reflection light of flash light from an object and an optical viewfinder 31 are also provided.

On the front face side of the camera body portion 2, a grip portion 4 is provided in a left end. On the upper side of the grip portion 4, an IRDA (Infrared Data Association) interface 236 for performing infrared communication with an external device is provided. In the center of the top, a built-in flash 5 is provided. On the top face side, a shutter button 8 is provided. The shutter button 8 is a two-level switch capable of detecting a half-pressed state and a full-pressed state, which is employed in a camera using a film.

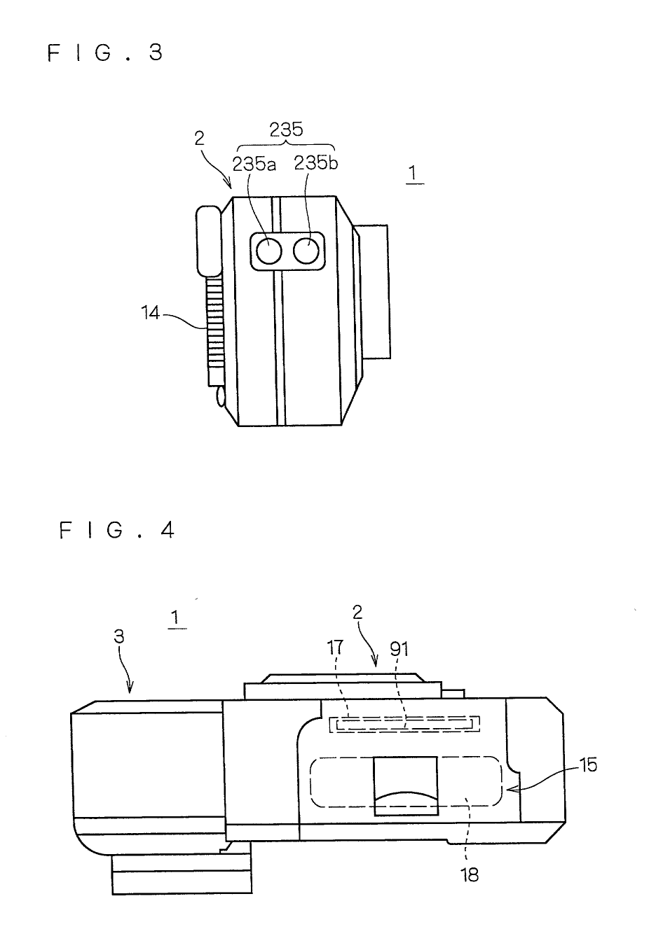

On the other hand, as shown in FIG. 2, on the rear side of the camera body portion 2, a liquid crystal display (LCD) 10 for performing “monitor display” (corresponding to a viewfinder) of captured images, reproduction display of recorded images, and the like is provided in an almost center. Below the LCD 10, a group of key switches 221 to 226 for operating the digital camera 1 and a power switch 227 are provided. On the left side of the power switch 227, an LED 228 which is turned on when the power is in the on state and an LED 229 indicating that a memory card is being accessed are arranged.

On the rear side of the camera body portion 2, a mode setting switch 14 for switching the mode between an “image capturing mode” and a “reproduction mode” is provided. The image capturing mode is a mode of taking a picture of an object and generating an image of the object, and the reproduction mode is a mode of reading the image recorded in a memory card and reproducing the image onto the LCD 10.

The mode setting switch 14 is a two-contact slide switch. When the mode setting switch 14 is slid and set to the lower position, the image capturing mode functions. When the mode setting switch 14 is slid and set to the upper position, the reproduction mode functions.

A four-way switch 230 is provided on the right side of the rear face of the camera. In the image capturing mode, by pressing buttons 231 and 232, zooming is carried out. By pressing buttons 233 and 234, exposure correction is made.

On the rear face of the image pickup portion 3, an LCD button 321 for turning on/off the LCD 10 and a macro button 322 are provided. Each time the LCD button 321 is pressed, the on/off state of the LCD display is switched. For example, when image capturing operation is performed by using only the optical viewfinder 31, the LCD display is turned off for the purpose of power saving. At the time of macro (close up) image capturing, by pressing the macro button 322, the image pickup portion 3 can perform macro image capturing.

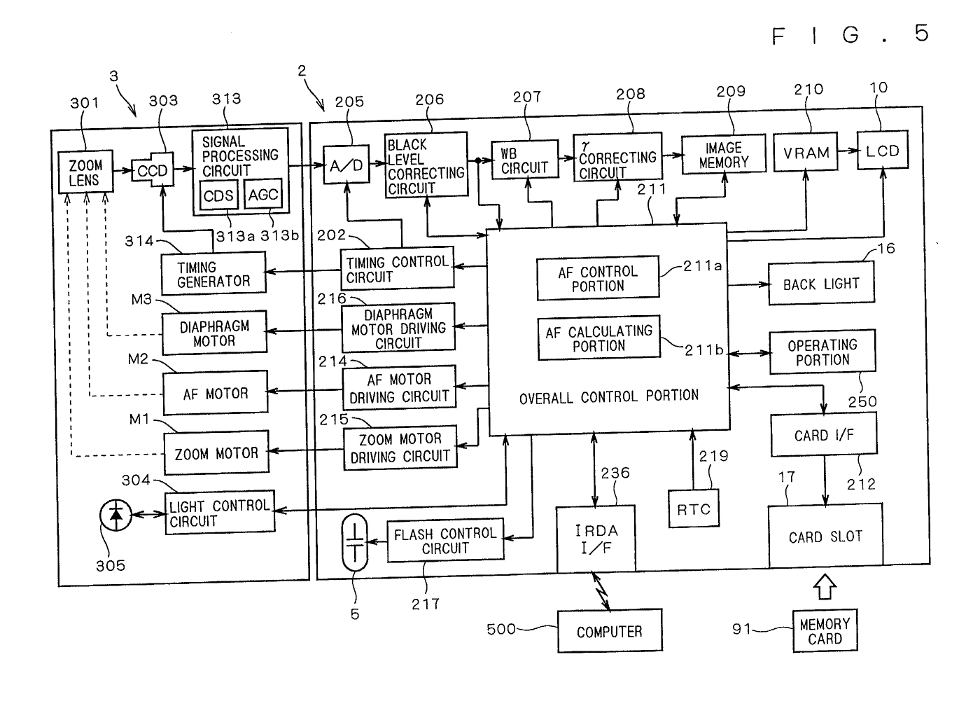

On a side face of the camera body portion 2, as shown in FIG. 3, a terminal portion 235 is provided. In the terminal portion 235, a DC input terminal 235a and a video output terminal 235b for outputting an image displayed on the LCD 10 to an external video monitor are provided.

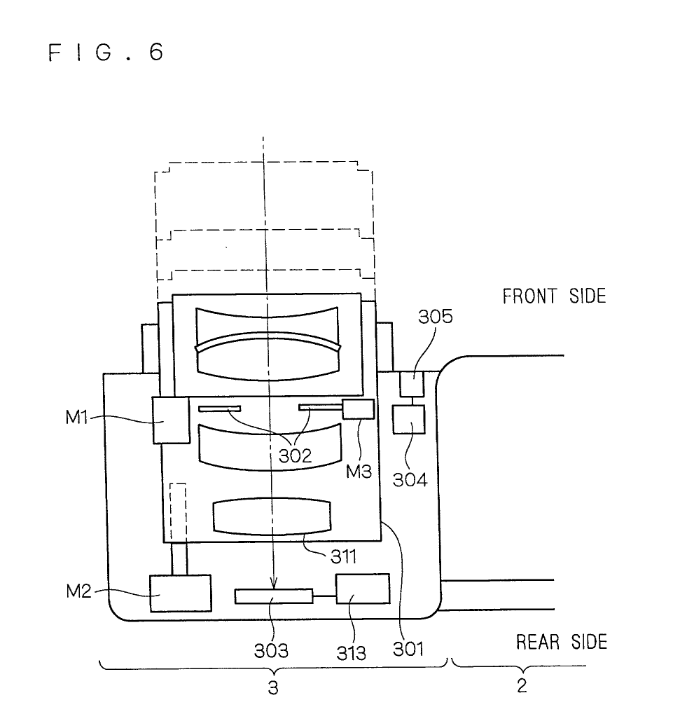

On the bottom face of the camera body portion 2, as shown in FIG. 4, a battery loading chamber 18 and a card slot (card loading chamber) 17 are provided. To the card slot 17, for example, a removable memory card 91 for recording a captured image and the like is loaded. The card slot 17 and the battery loading chamber 18 can be closed with a clamshell-type cover 15. In the digital camera 1, by loading four AA cells into the battery loading chamber 18, the power battery obtained by connecting the four AA cells in series is used as a power source. By attaching an adapter to the DC input terminal 235a shown in FIG. 3, power can be supplied from the outside to use the camera.

1.2 Internal Configuration of Digital Camera

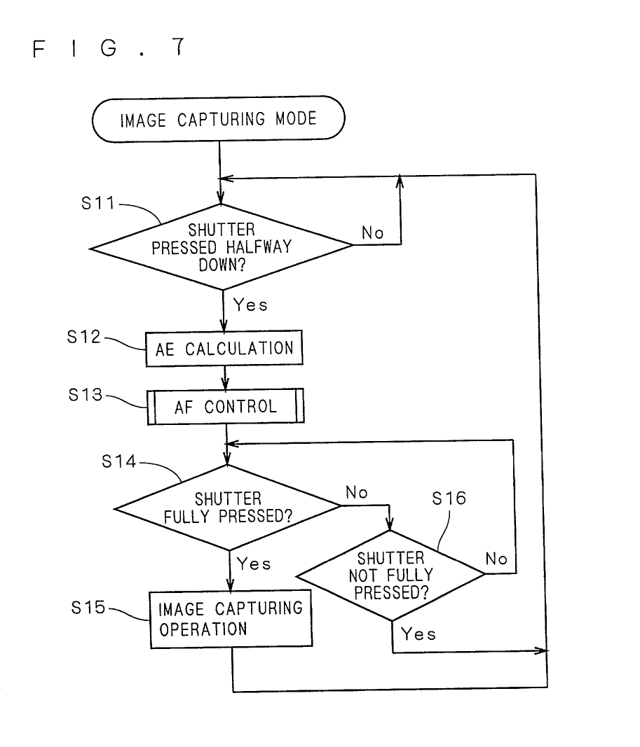

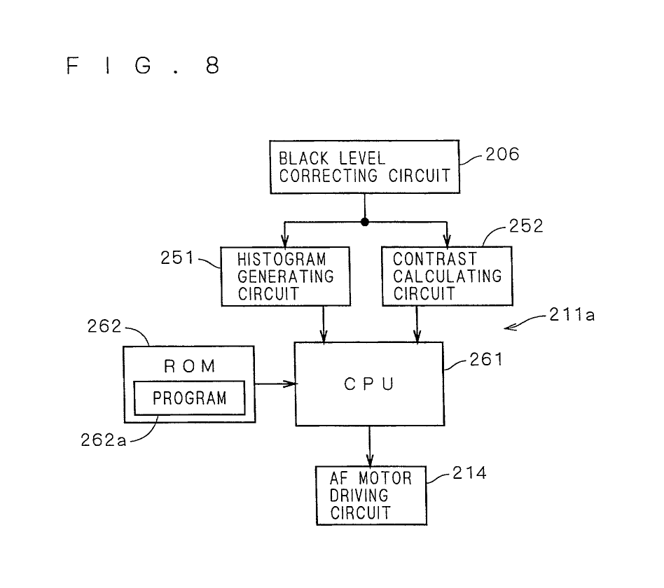

The configuration of the digital camera 1 will be described in more detail. FIG. 5 is a block diagram showing the configuration of the digital camera 1. FIG. 6 is a diagram schematically showing arrangement of the components of the image pickup portion 3.

As shown in FIG. 6, an image pickup circuit having a CCD 303 is provided in an appropriate position on the rear side of the zoom lens 301 in the image pickup portion 3. The image pickup portion 3 includes a zoom motor M1 for zooming of the zoom lens 301 and moving the lens between a housing position and an image capturing position, an autofocus motor (AF motor) M2 for moving a focusing lens 311 in the zoom lens 301 for automatically attaining focus, and a diaphragm motor M3 for adjusting the aperture of a diaphragm 302 provided in the zoom lens 301. As shown in FIG. 5, the zoom motor M1, AF motor M2, and diaphragm motor M3 are driven by a zoom motor driving circuit 215, an AF motor driving circuit 214, and a diaphragm motor driving circuit 216, respectively, which are provided for the camera body portion 2. The driving circuits 214 to 216 drive the motors M1 to M3 on the basis of a control signal supplied from an overall control portion 211 of the camera body portion 2.

The CCD 303 photoelectric-converts an optical image of the object formed by the zoom lens 301 into image signals of color components of R (red), G (green), and B (blue) (signals each of which is constructed by a signal train of pixel signals received by pixels), and outputs the image signals.

An exposure control in the image pickup portion 3 is performed by adjusting the diaphragm 302 and adjusting an exposure amount of the CCD 303, that is, charge accumulation time of the CCD 303 corresponding to shutter speed. When proper diaphragm and shutter speed cannot be set due to low brightness of the object, by adjusting the level of the image signal outputted from the CCD 303, improper exposure due to insufficient exposure is corrected. That is, in the case of low brightness, a control is performed by a combination of the shutter speed and gain adjustment so that the exposure level becomes a proper level. The level of the image signal is adjusted by adjusting the gain of an AGC (Auto Gain Control) circuit 313b in a signal processing circuit 313.

A timing generator 314 generates a drive control signal for the CCD 303 on the basis of a reference clock transmitted from a timing control circuit 202 in the camera body portion 2. The timing generator 314 generates, for example, clock signals such as timing signals of start/end of integration (start/end of exposure) and read control signals of photoreception signals of pixels (horizontal sync signal, vertical sync signal, transfer signal, and the like), and outputs the signals to the CCD 303.

The signal processing circuit 313 performs a predetermined analog signal process on the image signal (analog signal) outputted from the CCD 303. The signal processing circuit 313 has a CDS (correlation double sampling) circuit 313a and the AGC circuit 313b, reduces noises in the image signal by the CDS circuit 313a, and adjusts the gain by the AGC circuit 313b, thereby adjusting the level of the image signal.

A light control circuit 304 controls the light emission amount of the built-in flash 5 at the time of image capturing with flash to a predetermined light emission amount set by the overall control portion 211. At the time of image capturing with flash, simultaneously with start of exposure, reflection light of flash light from the object is received by the light control sensor 305. When the photoreception amount reaches a predetermined light emission amount, a light emission stop signal is output from the light control circuit 304. The light emission stop signal is led to a flash control circuit 217 via the overall control portion 211 provided for the camera body portion 2. In response to the light emission stop signal, the flash control circuit 217 forcedly stops light emission of the built-in flash 5, thereby controlling the light emission amount of the built-in flash 5 to a predetermined light emission amount.

The blocks in the camera body portion 2 will now be described.

In the camera body portion 2, an A/D converter 205 converts pixel signals of an image to a digital signal of, for example, 10 bits. The A/D converter 205 converts pixel signals (analog signals) to a 10-bit digital signal synchronously with clocks for A/D conversion supplied from the timing control circuit 202.

The timing control circuit 202 is constructed to generate reference clocks, that is, clocks to the timing generator 314 and A/D converter 205. The timing control circuit 202 is controlled by the overall control portion 211 including a CPU (Central Processing Unit).

A black level correcting circuit 206 corrects the black level of the A/D converted image to a reference black level. A WB (white balance) circuit 207 converts the level of each of color components R, G, and B of pixels so that white balance is also adjusted after y correction. The WB circuit 207 converts the level of each of the color components R, G, and B of pixels by using a level conversion table supplied from the overall control portion 211. A conversion coefficient (gradient of characteristic) of each of the color components in the level conversion table is set for each captured image by the overall control portion 211.

A γ correcting circuit 208 corrects the γ characteristic of an image. An image memory 209 is a memory for storing data of the image outputted from the γ correcting circuit 208. The image memory 209 has a storage capacity of one frame. Specifically, when the CCD 303 has pixels in (n) rows and (m) columns, the image memory 209 has the storage capacity of data of n×m pixels, and data of each pixel is stored into a corresponding address.

A VRAM (video RAM) 210 is a buffer memory of an image to be reproduced and displayed on the LCD 10. The VRAM 210 has a storage capacity capable of storing image data corresponding to the number of pixels of the LCD 10.

In an image capture standby state in the image capturing mode, when the LCD indication is the ON state by the LCD button 321 (refer to FIG. 2), a live view is displayed on the LCD 10. Concretely, each of images captured every predetermined intervals from the image pickup portion 3 is subjected to various signal processes by the A/D converter 205, black level correcting circuit 206, WB circuit 207, and γ correcting circuit 208. After that, the overall control portion 211 obtains an image to be stored into the image memory 209 and transfers it to the VRAM 210, thereby displaying the captured image on the LCD 10. By updating the image displayed on the LCD 10 every predetermined time, live view display is performed. By the live view display, the user can visually recognize the object by the image displayed on the LCD 10. At the time of displaying an image on the LCD 10, a back light 16 is turned on by the control of the overall control portion 211.

In the reproducing mode, an image read from the memory card 91 is subjected to a predetermined signal process in the overall control portion 211, and a processed image is transferred to the VRAM 210 and is reproduced and displayed on the LCD 10.

A card I/F 212 is an interface used for writing/reading an image to/from the memory card 91 via the card slot 17.

The flash control circuit 217 is a circuit for controlling light emission of the built-in flash 5, allows the built-in flash 5 to emit light on the basis of the control signal from the overall control portion 211 and, on the other hand, stops the light emission of the built-in flash 5 on the basis of the above-described light emission stop signal.

An RTC (Real Time Clock) circuit 219 is a clock circuit for managing date of image capturing.

The IRDA interface 236 is connected to the overall control portion 211, so that infrared wireless communication can be performed with an external device such as a computer 500 or another digital camera via the IRDA interface 236 and an image can be wireless-transferred.

An operating portion 250 includes the above-described various switches and buttons, and information input by the user is transmitted to the overall control portion 211 via the operating portion 250.

The overall control portion 211 organically controls the driving of the above-described members in the image pickup portion 3 and the camera body portion 2 to thereby control the entire operation of the digital camera 1.

The overall control portion 211 has an AF (autofocus) control portion 211a for performing operation control to efficiently attain automatic focus and an AE (auto exposure) calculating portion 211b for performing automatic exposure.

An image output from the black level correcting circuit 206 is input to the AF control portion 211a, an evaluation value to be used for autofocus is calculated, and the components are controlled by using the evaluation value, thereby making the position of an image formed by the zoom lens 301 coincide with the light receiving surface of the CCD 303, where an image is formed.

An image output from the black level correcting circuit 206 is also input to the AE calculating portion 211b, and an appropriate value based on the shutter speed and the aperture size of the diaphragm 302 in accordance with a predetermined program. The AE calculating portion 211b calculates an appropriate value based on the shutter speed and the aperture size of the diaphragm 302 in accordance with a predetermined program on the basis of the brightness of the object.

Further, in the image capturing mode, when image capturing is instructed by the shutter button 8, the overall control portion 211 generates a thumbnail image of the image stored in the image memory 209 and an image compressed in the JPEG system at a set compression ratio set by a switch included in the operating portion 250, and stores both of the images together with tag information regarding the captured images (information such as frame number, exposure value, shutter speed, compression ratio, image capturing date, data of on/off of the flash at the time of image capturing, scene information, result of determination of an image, and the like) into the memory card 91.

When the mode setting switch 14 for switching the mode between the image capturing mode and the reproducing mode is set to the reproducing mode, for example, image data of the largest frame number in the memory card 91 is read and decompressed in the overall control portion 211, and the resultant image data is transferred to the VRAM 210 to display the image of the largest frame number, that is, the image most recently captured on the LCD 10.

1.3 Outline of Operation of Digital Camera

The outline of the operation in the digital camera 1 will now be described. FIG. 7 is a diagram schematically showing the operation of the digital camera 1.

When the operation of the digital camera 1 is set to the image capturing mode by the mode setting switch 14, the digital camera 1 enters a state of waiting for the moment that the shutter button 8 is pressed halfway down (step S11). When the shutter button 8 is pressed halfway down, a signal indicating a half press of the button 8 is input to the overall control portion 211, and an AE calculation (step S12) and an AF control (step S13) as preparation for capturing an image are executed by the overall control portion 211. That is, the instruction of the preparation for capturing an image is given to the overall control portion 211 by the shutter button 8.

In the AE calculation, exposure time and aperture value (f-number) are calculated by the AE calculating portion 211b. In the AF control, the zoom lens 301 is set to a focused state by the AF control portion 211a. After that, the digital camera 1 shifts to a state where it waits for a full press of the shutter button 8 (step S14).

When the shutter button 8 is fully pressed, a signal from the CCD 303 is converted to a digital signal and the digital signal is stored as image data to the image memory 209 (step S15). By the operation, the image of the object is captured.

After completion of the image capturing operation or when the shutter bottom 8 is not fully pressed after pressed halfway down (step S16), the process returns to the first stage.

1.4 Autofocusing Control

The configuration of the AF control portion 211a and an autofocus (AF) control in the first preferred embodiment will now be described.

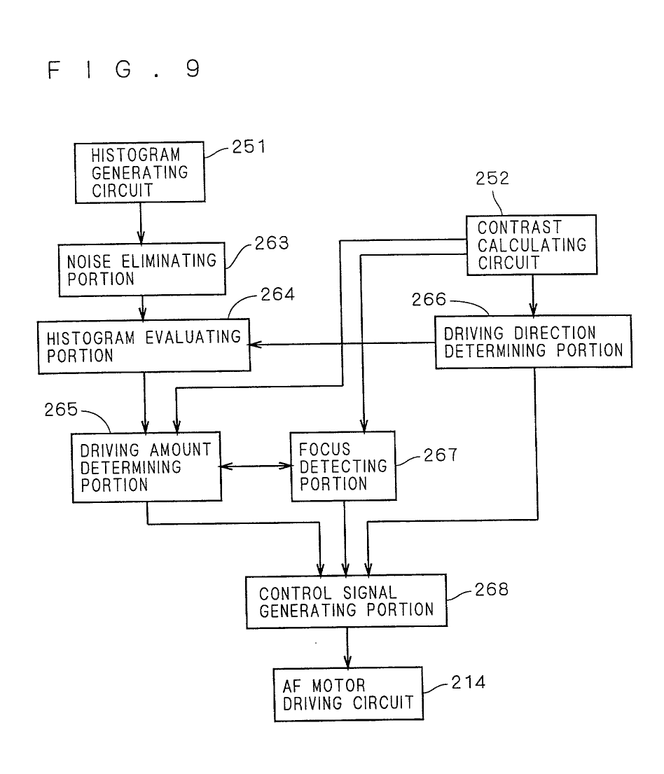

FIG. 8 is a block diagram showing the configuration of the AF control portion 211a illustrated in FIG. 5 together with the configuration of peripheral components. The AF control portion 211a has a histogram generating circuit 251 and a contrast calculating circuit 252 to each of which an image is input from the black level correcting circuit 206. Further, a CPU 261 and an ROM 262 in the overall control portion 211 realize a part of the functions of the AF control portion 211a.

The histogram generating circuit 251 detects edges in an image and generates a histogram of edge widths. The contrast calculating circuit 252 calculates contrast of the image. The details of the configurations will be described hereinlater.

The CPU 261 performs an operation in accordance with a program 262a in the ROM 262, thereby performing a part of the autofocusing operation and transmitting a control signal to the AF motor driving circuit 214. The program 262a may be stored in the ROM 262 on manufacture of the digital camera 1. It is also possible to use the memory card 91 as a recording medium on which a program is recorded and transfer the program from the memory card 91 to the ROM 262.

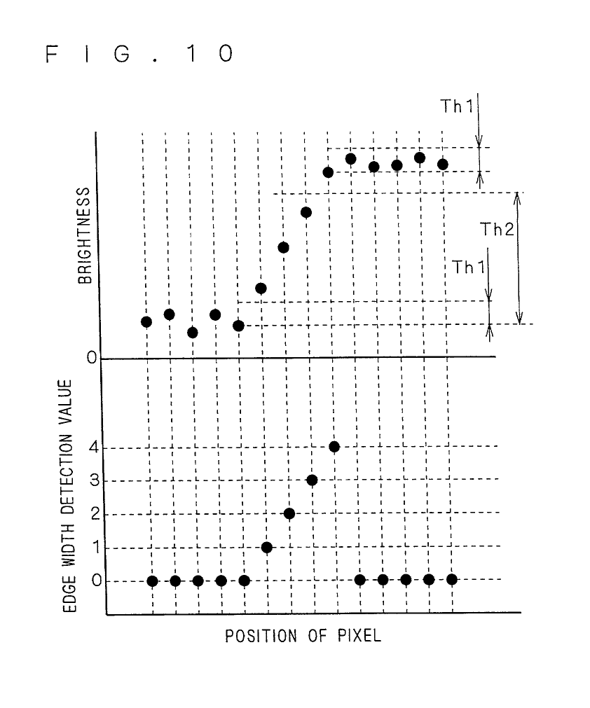

FIG. 9 is a block diagram showing the functions of the CPU 261 at the time of autofocus and also the other components. In FIG. 9, the components corresponding to the functions realized by performing computing processes by the CPU 261 are: a noise eliminating portion 263 for eliminating noise components from a histogram generated by the histogram generating circuit 251; a histogram evaluating portion 264 for obtaining an evaluation value indicative of the degree of achieving focus from the histogram; a driving amount determining portion 265 for obtaining a driving amount of the AF motor M2 for changing the position of the focusing lens 311; a driving direction determining portion 266 for determining the driving direction of the AF motor M2 (that is, the driving (moving) direction of the focusing lens 311) by using the contrast from the contrast calculating circuit 252, a focus detecting portion 267 for detecting whether the optical system is in a focused state or not, and a control signal generating portion 268 for generating a control signal to the AF motor M2 and supplying the signal to the AF motor driving circuit 214. The lens driving control is substantially executed by the driving amount determining portion 265, driving direction determining portion 266, and focus detecting portion 267.

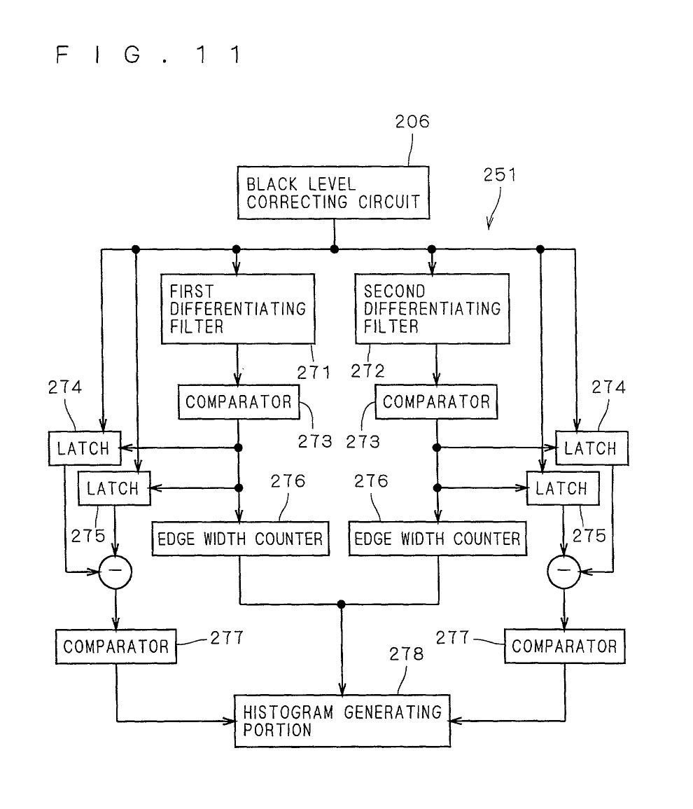

FIG. 10 is a diagram for explaining an state of edge detection in the histogram generating circuit 251. In FIG. 10, the horizontal axis denotes the position of a pixel in the horizontal direction. The upper part of the vertical axis corresponds to brightness of a pixel, and the lower part of the vertical axis corresponds to a detection value of an edge width.

In the case where edges are detected from the left to the right in FIG. 10, when the brightness difference between adjacent pixels is equal to or smaller than a threshold value Th1, it is determined that no edge exists. On the other hand, when the brightness difference exceeds the threshold value Th1, it is determined that the start end of an edge exists. When the brightness difference exceeding the threshold value Th1 continuously exists in the direction from the left to the right, an edge width detection value increases.

After detecting the edge start end, when the brightness difference becomes equal to or smaller than the threshold value Th1, it is determined that an edge termination exists. When the brightness difference between the pixel corresponding to the edge start end and the pixel corresponding to the termination is equal to or smaller than a threshold value Th2, it is determined that the edge is not a proper edge. When the brightness difference exceeds the threshold value Th2, it is determined that the edge is a proper edge.

By performing the processes on the pixel arrangement in the horizontal direction in an image, the value of the edge width in the horizontal direction in the image is detected.

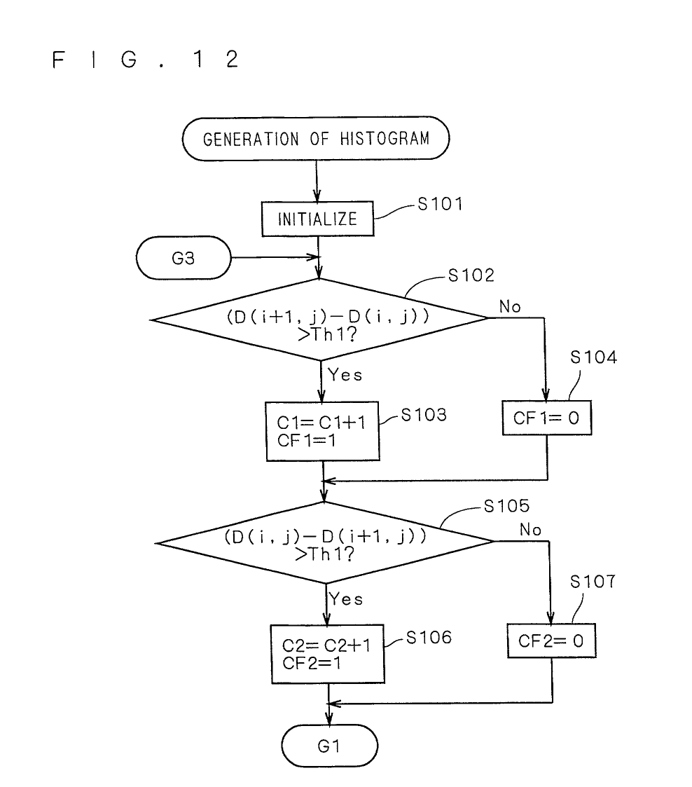

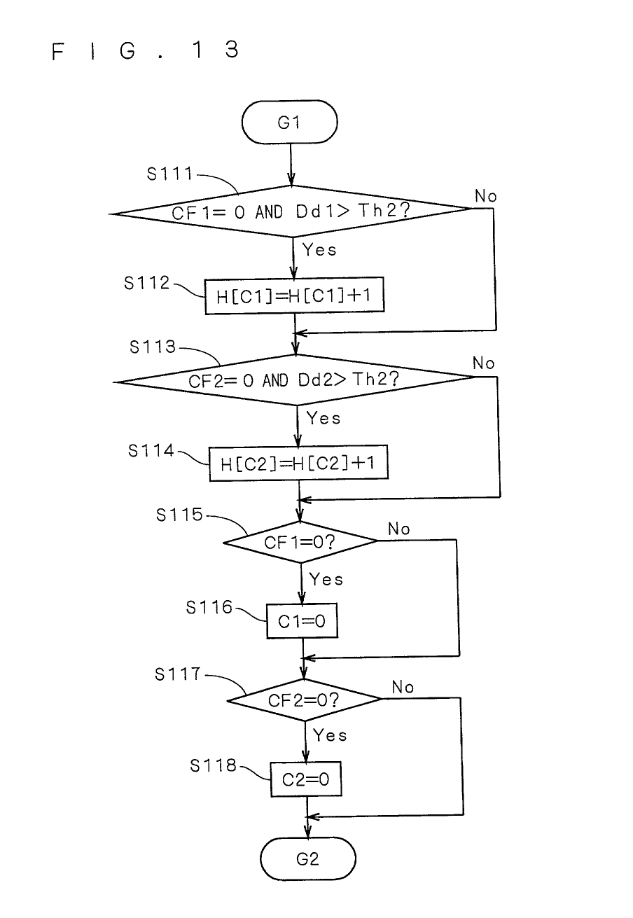

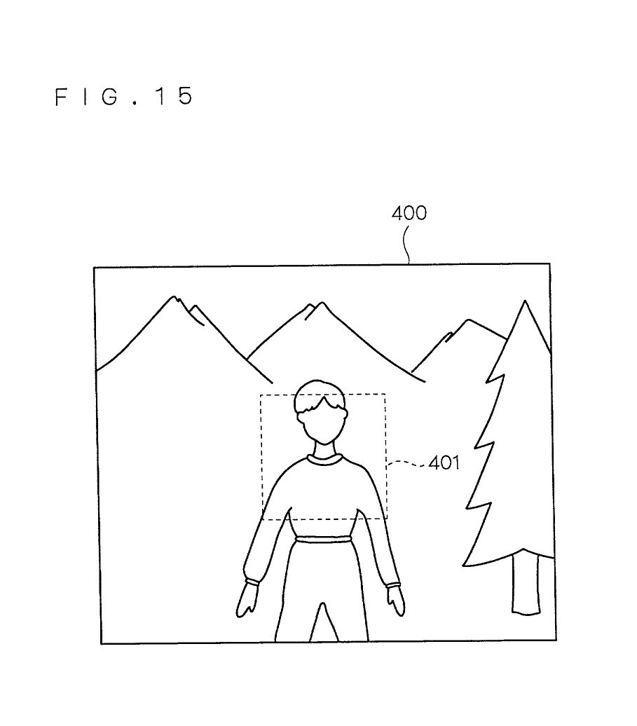

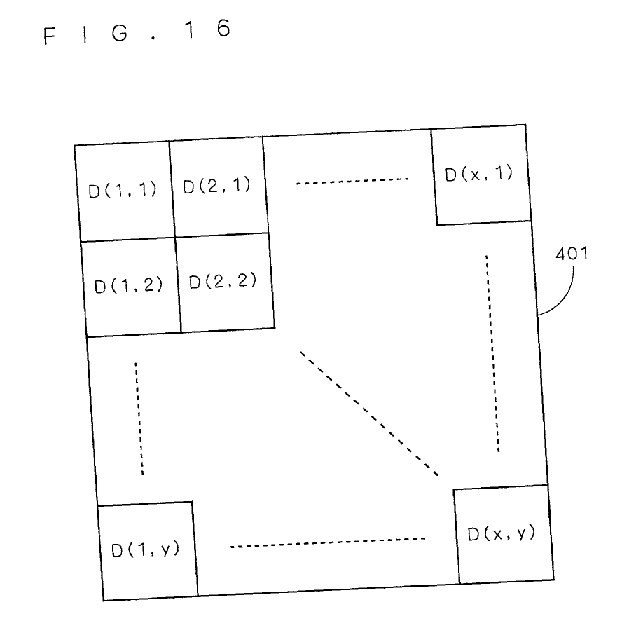

FIG. 11 is a diagram showing a concrete configuration of the histogram generating circuit 251. FIGS. 12 to 14 are diagrams showing the flow of operations of the histogram generating circuit 251. Referring to those diagrams, generation of a histogram will be described in more detail hereinbelow. It is assumed that an area 401 to be automatically focused (hereinbelow, called “AF area”) is preset in the center of an image 400 as shown in FIG. 15, and the brightness of a pixel in coordinates (i, j) in the AF area 401 is expressed as D(i, j) as shown in FIG. 16.

In the histogram generating circuit 251 connected to the black level correcting circuit 206, as shown in FIG. 11, the left-side structure in which a first differentiating filter 271 is provided and the right-sight structure in which a second differentiating filter 272 is provided are symmetrical with respect to a center line. When an image is scanned from the left to the right, an edge corresponding to a rise in brightness is detected by the structure on the first differentiating filter 271 side, and an edge corresponding to a fall in brightness is detected by the structure on the second differentiating filter 272 side.

In the histogram generating circuit 251, first, various variables are initialized (step S101). After that, a brightness difference (D(i+1, j)−D(i,j)) between neighboring pixels is obtained by the first differentiating filter 271, and whether the brightness difference exceeds the threshold value Th1 or not is determined by a comparator 273 (step S102). When the brightness difference is equal to or smaller than the threshold value Th1, it is determined that no edge exists.

On the other hand, a brightness difference (D(i,j)−D(i+1,j)) between neighboring pixels is also obtained by the second differentiating filter 272, and whether the brightness difference exceeds the threshold value Th1 or not is determined by the comparator 273 (step S105). When the brightness difference is equal to or lower than the threshold value Th1, it is determined that no edge exists.

After that, steps S102 and S105 are repeated while increasing i (steps S121 and S122 in FIG. 14).

In step S102, when the brightness difference exceeds the threshold value Th1, it is determined that the start end of an edge (the rising of the brightness signal) is detected, an edge width detection value C1 (initial value 0) indicative of an edge width is incremented by an edge width counter 276 on the first differentiating filter 271 side, and a flag CF1 indicating that the edge width is being detected is set to 1 (step S103). Further, the brightness on start of detection is stored in a latch 274.

After that, the edge width detection value C1 increases (steps S102, S103, S121, and S122) until the brightness difference becomes the threshold value Th1 or smaller in step S102. When the brightness difference becomes equal to or smaller than the threshold value Th1, the flag CF1 is reset to 0, and the brightness at this time is stored in a latch 275 (steps S102 and S104).

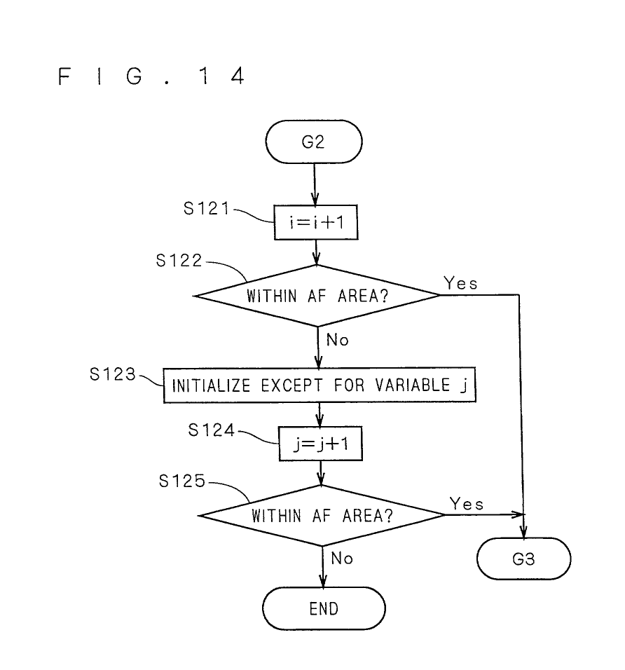

When the flag CF1 is reset to 0, a difference Dd1 between the brightness stored in the latch 274 and the brightness stored in the latch 275 is supplied to a comparator 277 in which whether the brightness difference Dd1 exceeds the threshold value Th2 or not is checked (step S11 in FIG. 13). When the brightness difference Dd1 exceeds the threshold value Th2, it is determined that a proper edge is detected, the edge width detection value C1 is supplied from the edge width counter 276 to a histogram generating portion 278, and a frequency H[C1] of appearance of the edge having the edge width of C1 is incremented (step S112). By the operation, the detection of an edge having the edge width of C1 is completed.

After that, the edge width detection value C1 is reset to 0 (steps S15 and S116).

Similarly, also in the case where the brightness difference exceeds the threshold value Th1 in step S105, it is determined that the start end of an edge (the falling of the brightness signal) is detected, an edge width detection value C2 (initial value 0) indicative of an edge width is incremented by the edge width counter 276 on the second differentiating filter 272 side, and a flag CF2 indicating that the edge width is being detected is set to 1, and the brightness on start of detection is stored in the latch 274 (steps S105 and S106).

After that, the edge width detection value C2 increases (steps S105, S106, S121, and S122) until the brightness difference becomes equal to or smaller than the threshold value Th1 in step S105. When the brightness difference becomes equal to or smaller than the threshold value Th1, the flag CF2 is reset to 0, and the brightness at this time is stored in a latch 275 (steps S105 and S107).

When the flag CF2 is reset to 0, a difference Dd2 between the brightness stored in the latch 274 and the brightness stored in the latch 275 is supplied to the comparator 277 in which whether the brightness difference Dd2 exceeds the threshold value Th2 or not is checked (step S113). When the brightness difference Dd2 exceeds the threshold value Th2, a frequency H[C2] of appearance of the edge having the edge width of C2 is incremented by the histogram generating portion 278 (step S114). By the operation, the detection of an edge having the edge width of C2 is completed.

After that, the edge width detection value C2 is reset to 0 (steps S117 and S118).

When the edge detecting process is repeated and a variable i becomes a value outside of the AF area 401 (to be accurate, when (i+1) becomes a value outside of the AF area 401), values other than a variable j are initialized and the variable j is incremented (steps S122 to S124 in FIG. 14). In such a manner, edge detection is performed on the next pixel arrangement in the horizontal direction in the AF area 401. When the edge detection in the horizontal direction is repeated and the variable j becomes a value outside of the AF area 401, the edge detection is finished (step S125). By the operation, a histogram showing the relation between the edge width and the frequency is generated in the histogram generating portion 278.

The contrast calculating circuit 252 shown in FIG. 9 will now be described. In the digital camera 1, the contrast of the AF area 401 is also used at the time of the AF control. As contrast, any index value showing the degree of a change in brightness in the AF area 401 may be used. In the digital camera 1, a value shown by Equation 1 is used as contrast Vc. That is, as the contrast Vc, a sum of brightness differences of neighboring pixels in the horizontal direction is used.

$$Vc = {\sum }_{j = 1}^{y} {\sum }_{i = 1}^{x - 1} \vert D ( i + 1 , j ) - D ( i , j ) \vert \qquad [ Equation 1 ]$$

where, x denotes the number of pixels in the horizontal direction in the AF area 401, and y denotes the number of pixels in the vertical direction (refer to FIG. 16). Although not shown, the contrast calculating circuit 252 has a structure of accumulating outputs from the first and second differentiating filters 271 and 272 shown in FIG. 11. Alternately, a contrast detecting circuit may be separately provided. In the contrast detection, a difference between not neighboring pixels but pixels which are neighboring with one pixel therebetween may be also calculated.

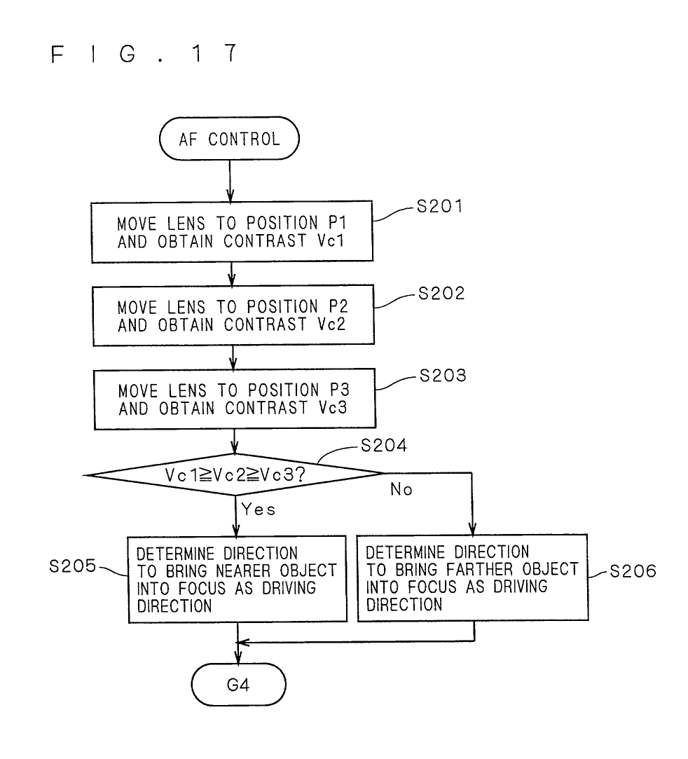

FIGS. 17 to 19 are diagrams showing the general flow of the AF control (step S13 in FIG. 7) in the digital camera 1. By referring to FIGS. 17 to 19 and FIG. 9, the operation at the time of autofocus will be described. In the following description, the focusing lens 311 driven at the time of autofocus will be properly simply called a “lens”, and the position of the focusing lens 311 at which the optical system enters a focus state will be called an “in-focus position”.

First, by the control of the control signal generating portion 268, the lens is moved by a predetermined amount from a reference position P2 to a position P1, i.e., in a direction to bring a nearer object into focus, where the contrast calculating circuit 252 calculates contrast Vc1 and outputs the contrast Vc1 to the driving direction determining portion 266 (step S201). Subsequently, the lens is returned to the reference position P2 where contrast Vc2 is calculated (step S202), and is further moved by a predetermined amount to a position P3, i.e., in a direction to bring a farther object into focus, where contrast Vc3 is calculated (step S203).

The driving direction determining portion 266 checks whether the contrast Vc1, Vc2, and Vc3 satisfies the condition (Vc1≧Vc2≧Vc3) or not (step S204). When the condition is satisfied, the in-focus position exists in the direction to bring a nearer object into focus with respect to the present position P3. Consequently, the driving direction is determined as the direction to bring a nearer object into focus. When the condition is not satisfied, the driving direction is determined as the direction to bring a farther object into focus (steps S205 and S206).

Subsequently, in a state where the lens is positioned in the position P3, a histogram of edge widths is generated by the histogram generating circuit 251, noise components in the histogram are eliminated by the noise eliminating portion 263, after that, the number Ven of edges detected by the histogram evaluating portion 264 is obtained and, further, a representative value of the histogram is computed (step S301). As a representative value of the histogram, an edge width corresponding to the center of gravity of the histogram (hereinbelow, called “center-of-gravity edge width”) Vew is used in the digital camera 1. As a representative value of the histogram, other statistical values may be used. For example, an edge width at the peak of the histogram, median of edge widths, and the like can be used.

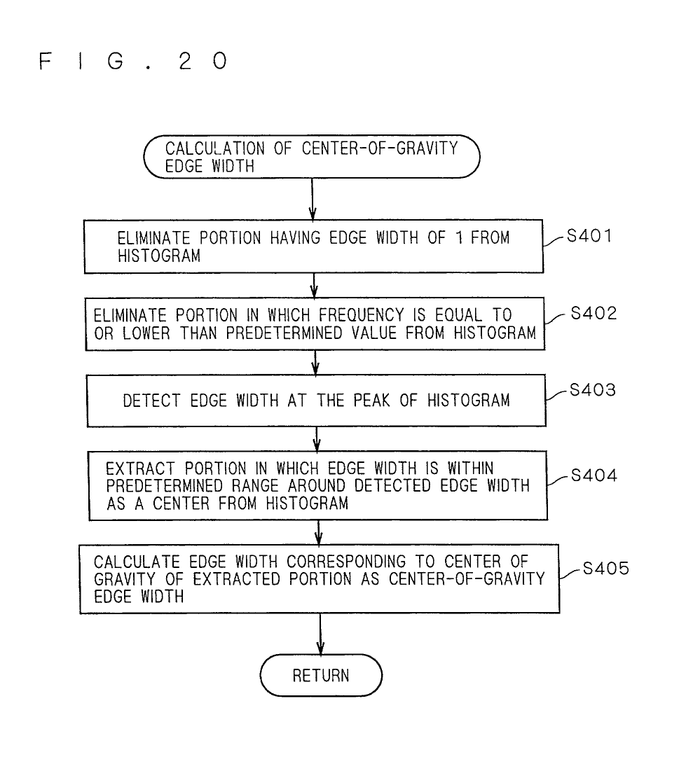

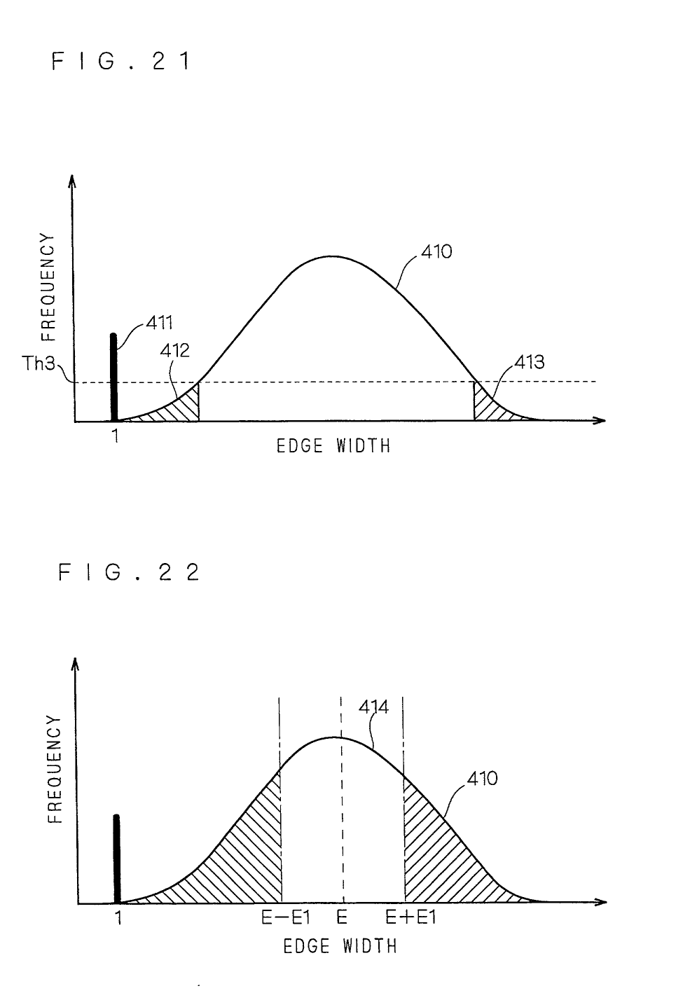

FIG. 20 is a flowchart showing the details of processes for obtaining the center-of-gravity edge width by the noise eliminating portion 263 and the histogram evaluating portion 264. FIGS. 21 and 22 are diagrams for explaining the state of operations of the noise eliminating portion 263.

In the noise eliminating operation by the noise eliminating portion 263, first, a region where the edge width is 1 (that is, one pixel) is eliminated from the histogram (step S401). As shown in FIG. 21, a histogram 410 has a shape in which a region 411 where the edge width is 1 is projected for the reason that a high frequency noise in the AF area 401 is detected as an edge having the width of 1. By eliminating the region 411 where the edge width is 1, improved precision of the center-of-gravity edge width which will be described hereinlater is realized.

Subsequently, regions 412 and 413 where the frequency is equal to or lower than a predetermined value Th3 are eliminated from the histogram 410 (step 402) for the reason that the region where the frequency is low in the histogram 410 generally includes a number of edges of things other than a main object. In other words, a region where the frequency is higher than a predetermined value is extracted from the histogram.

Further, as shown in FIG. 22, an edge width E at the peak of the histogram is detected (step S403) and a new histogram 41 is obtained by extracting a region where the edge width falls within a predetermined range around the edge width E as a center (within the range where the edge width is between (E−E1) and (E+E1) in FIG. 22) (step S404). Although not shown in FIGS. 21 and 22, depending on the shape of the histrogram, the regions 412 and 413 eliminated in FIG. 21 are not always included in the region to be eliminated in FIG. 22. Consequently, after step S402, step S404 is further executed.

The edge width E as a center of the extraction range in step S404 may be an edge width corresponding to the center of gravity of the histogram after step S402. To simplify the process, a method of simply eliminating a region where the edge width is equal to or smaller than a predetermined value or a region where the edge width is equal to or larger than a predetermined value from the histogram may be employed. Since the width of an edge of the main object (that is, an edge which does not include noise components led from a background image) lies usually in a predetermined range, a histogram almost corresponding to the main object image can be obtained even by such a simplified process.

After the noise components are eliminated from the histogram, the edge width corresponding to the center of gravity of the extracted histogram is obtained as a center-of-gravity edge width Vew by the histogram evaluating portion 264 (step S405).

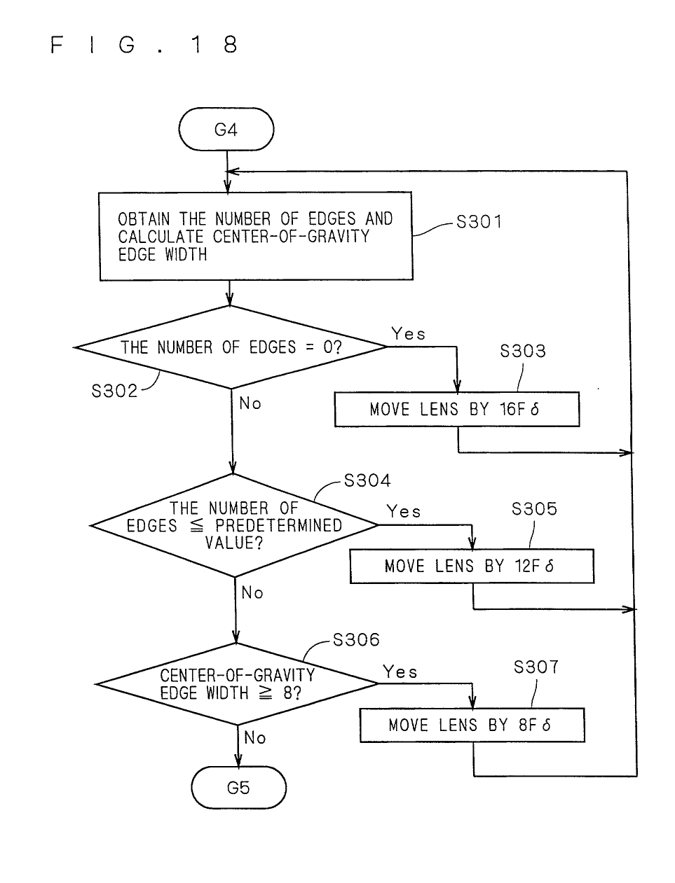

As the number Ven of edges obtained in step S301 in FIG. 18, total frequency in the histogram from which the noise components have been eliminated in step S402 or total frequency in the histogram from which the noise components have been further eliminated in step S404 may be used.

After the number Ven of edges and the center-of-gravity edge width Vew are computed by the histogram evaluating portion 264, whether the number Ven of edges is 0 or not is checked. When the number Ven of edges is not zero, whether the number Ven of edges is equal to or smaller than a predetermined value is checked. When the number Ven of edges is not equal to or smaller than the predetermined value, whether the center-of-gravity edge width Vew is equal to 8 or larger is sequentially checked (steps S302, S304, and S306).

When the number Ven of edges is 0, a movement amount of an image surface by the driving of the lens is determined as 16 Fδ by the driving amount determining portion 265, and the lens is driven to the direction determined by the driving direction determining portion 266 (step S303). F denotes an aperture value (f-number), δ denotes a diameter of a permissible circle of confusion corresponding to the pitch (interval) of pixels in the CCD 303, and Fδ corresponds to depth of focus. In the case of performing the AF control by using a lens for focusing, since the movement amount of the image surface is equal to the movement amount of the lens, the movement amount of the lens is determined as 16 Fδ in reality.

When the number Ven of edges is equal to or smaller than the predetermined value, the lens is driven so as to move only by 12 Fδ (step S305). When the center edge width Vew is 8 or wider, the lens is driven so as to move only by 8 Fδ (step S307). The calculation of the number Ven of edges and the center-of-gravity edge width Vew and driving of the lens are performed repeatedly until the center-of-gravity edge width Vew becomes a value smaller than 8 (steps S301 to S307).

As described above, the AF control portion 211a determines the amount of driving the lens by using the number Ven of edges and the center-of-gravity edge width Vew for the reason that those values can be used as evaluation values indicative of the degree of achieving focus and, the lower the degree of achieving focus is, that is, the more the lens is apart from the in-focus position, the lens is allowed to be largely moved by a single driving.

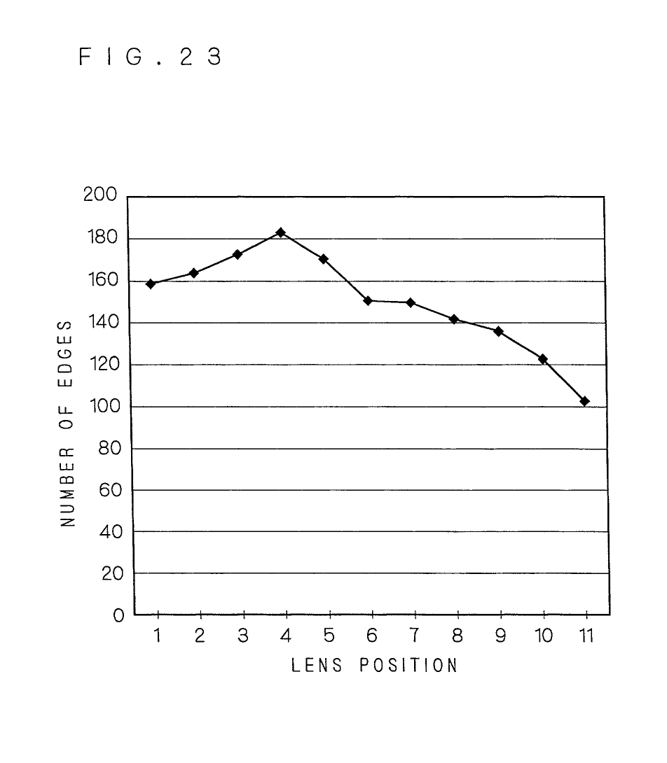

FIG. 23 is a diagram for explaining that the number Ven of edges can be used as an evaluation value regarding focusing. In FIG. 23, the lateral axis corresponds to the position of the lens, and the vertical axis corresponds to the total number of edges detected (that is, the number Ven of edges). In FIG. 23, when the lens position is 4, the lens is positioned in the in-focus position. At this time, the number of edges becomes the maximum. The more the lens position is apart from the in-focus position, the number of edges decreases. As described above, the number of edges can be used as an evaluation value indicative of the degree of achieving focus.

On the other hand, as the lens approaches the in-focus position, the image becomes sharper, and the width of each edge detected is reduced. Naturally, the center-of-gravity edge width Vew can be also used as an evaluation value indicative of the degree of achieving focus. In this case, the higher the degree of achieving focus becomes, the smaller the evaluation value becomes. If it is defined that the higher the degree of achieving focus becomes, the larger the evaluation value becomes, an inverse number of the center-of-gravity edge width Vew, a value obtained by subtracting the center-of-gravity edge width Vew from a predetermined value, or the like corresponds to the evaluation value.

In the case of the digital camera 1, it was confirmed by experiments that the lens does not pass the in-focus position even if the lens is moved by 16 Fδ when the number Ven of edges is zero, by 12 Fδ when the number Ven of edges is equal to or smaller than a predetermined value (for example, 20), or by 8 Fδ when the center edge width Vew is 8 or wider. For the above reason, the control of driving the lens by steps S301 to S307 show in FIG. 18 is executed.

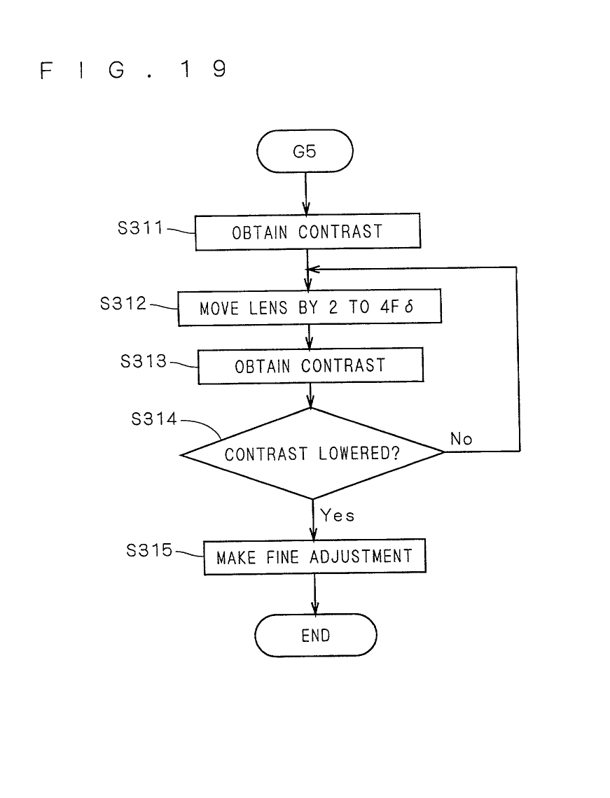

When the lens approaches the in-focus position, the center-of-gravity edge width Vew becomes smaller than 8 (pixels). After that, the lens is driven by a normal contrast method. Specifically, the contrast calculating circuit 252 calculates the contrast Vc (step S311 in FIG. 19), the driving amount determining portion 265 determines the lens driving amount so that the movement amount lies in a range from 2 to 4 Fδ in accordance with the contrast Vc, and the control signal generating portion 268 supplies a control signal corresponding to the driving amount to the AF motor driving circuit 214, thereby driving the AF motor M2 (step S312).

After that, the contrast Vc is calculated again. While checking whether the contrast Vc has decreased or not by the focus detecting portion 267, the driving amount determining portion 265 moves the lens little by little (steps S312 to S314). As the calculation of the contrast Vc and the driving of the lens are repeated, the lens passes the in-focus position, and the contrast Vc is lowered (step S314). By interpolating contrast Vc corresponding to a plurality of lens positions around the present lens position, the lens position at which the contrast Vc becomes the highest is calculated as an in-focus position. Further, while vibrating the lens, the contrast Vc is calculated, thereby performing fine adjustment of the lens position (step S315). By the operation, the AF control is completed.

When no edge is detected even if the lens is moved from an infinite end (an end where an object at infinity is in focus) to a nearest end (an end where the nearest object is in focus), it is determined by the AF control portion 211a that the object has low contrast, and warning that it is impossible to perform the AF control is notified to the user via the LCD 10. Also in the case where the number of edges does not exceed a predetermined value even when the lens is moved from the infinite end to the nearest end, warning is sent to the user via the LCD 10 or the in-focus position is detected by a normal method using contrast. Also in the case where the center-of-gravity edge width Vew does not become 8 or less, the method is switched to a normal method using contrast for detecting the in-focus position.

As described above, in the digital camera 1, edges in the AF area 401 are detected and an amount of single movement of the lens, that is, the lens driving speed is changed by using an evaluation value indicative of the degree of achieving focus regarding the edges. In such a manner, even a focusing operation with high precision for obtaining a high-resolution still image can be promptly performed.

Generally, in order to calculate a high-precision evaluation value from edges, it is preferable to obtain a histogram of the edge widths and use the representative value of the histogram as an evaluation value. In consideration of an arithmetic operation technique, preferably, the representative value of the histogram is given as a statistical value. As a statistical value, an average value, a median, an edge width corresponding to a peak, or the like can be used. In the digital camera 1, in consideration of the reliability of the evaluation value and the arithmetic amount by comparison, an edge width corresponding to the center of gravity of a histogram (that is, an average value of the edge widths) is used as a representative value.

As a concrete example of the evaluation value derived from edges, not only the center-of-gravity edge width Vew based on the histogram of edge widths but also the number Ven of edges can be used. In the digital camera 1, the evaluation values and a predetermined value are compared with each other, and the speed of driving the lens is changed according to the comparison result.

Generally, as an evaluation value regarding focus, the center-of-gravity edge width Vew using a histogram has precision higher than that of the number Ven of edges. On the other hand, the number Ven of edges is a value which can be very easily obtained. The digital camera 1 therefore uses both the low-precision evaluation value and the high-precision evaluation value. By using the low-precision evaluation value, whether the lens driving speed can be increased (the movement amount of once can be increased) or not is determined. By using the high-precision evaluation value, whether the lens driving speed can be decreased (the movement amount of once can be decreased) or not is determined. In such a manner, more appropriate AF control can be realized.

In the case of properly using a plurality of kinds of evaluation values, when it is determined that the lens is sufficiently apart from the in-focus position by using the low-precision evaluation value and comparison condition, determination under a high-precision comparison condition becomes unnecessary. It is substantially equivalent to determine whether a high-precision evaluation value is used or not by using a low-precision evaluation value.

In the digital camera 1, the number Ven of edges as a low-precision evaluation value is compared with a threshold value, the lens is largely moved in accordance with the result of comparison, after that, the number Ven of edges is calculated again, and the operation is repeated, thereby promptly driving the lens until the comparison result changes. When the comparison result changes, the driving operation using the center-of-gravity edge width Vew as a higher-precision evaluation value is performed. In such a manner, evaluation and driving are performed at a plurality of levels, and high-speed AF control is realized.

In the digital camera 1, at the time of obtaining the center-of-gravity edge width Vew, noise components derived from noises are eliminated from the histogram. Since most of the noise components are edges each having a width of 1 (pixel), by eliminating the region where the edge width is 1 from the histogram, effective noise removal is realized. Further, in the digital camera 1, attention is paid to an image of the main object, and regions assumed to be edges of things other than the main object are regarded as noises and eliminated from the histogram, thereby generating a more appropriate histogram. By eliminating noises, the high-speed, accurate AF control can be realized.

On the other hand, in the digital camera 1, by using not only the evaluation value of focus regarding edges but also the evaluation value of focus using contract, high-precision autofocus is realized. Concretely, the contrast Vc is used to determine the lens driving direction, and the final control is also performed by using the contrast Vc capable of increasing precision more than the center-of-gravity edge width.

The technique of obtaining contrast at the time of autofocus is a known technique. The digital camera 1 uses both the existing technique and the technique using edges. Further, by properly using evaluation value having different precision, such as the contrast Vc, center-of-gravity edge width Vew and the number Ven of edges, prompt and high-precision autofocus is realized. Generally, at the time of capturing a still image, the focusing lens largely moves in accordance with an instruction of preparation for image capture. Consequently, by changing the lens driving speed while using evaluation values of different precision, the autofocus at the time of capturing a still image can be realized promptly and properly.

2. Second Preferred Embodiment

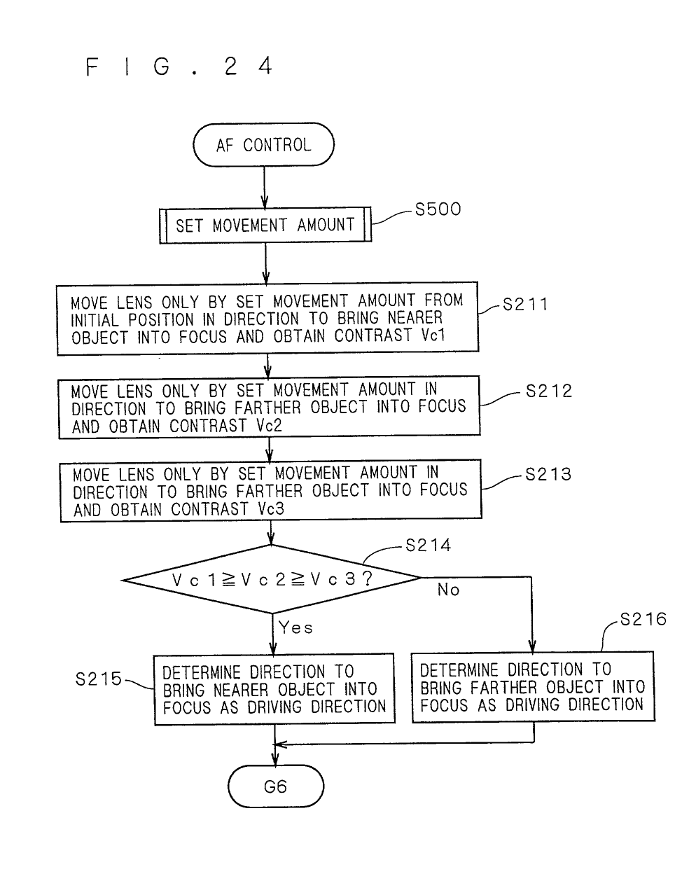

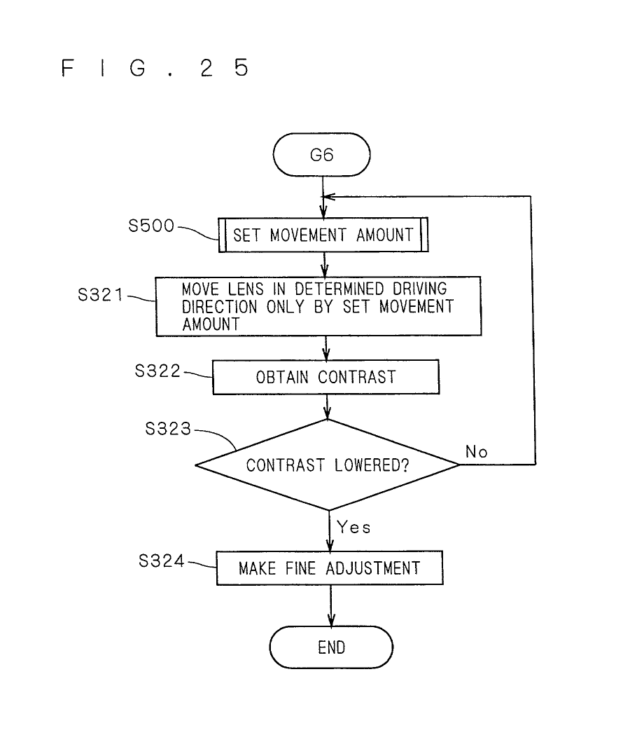

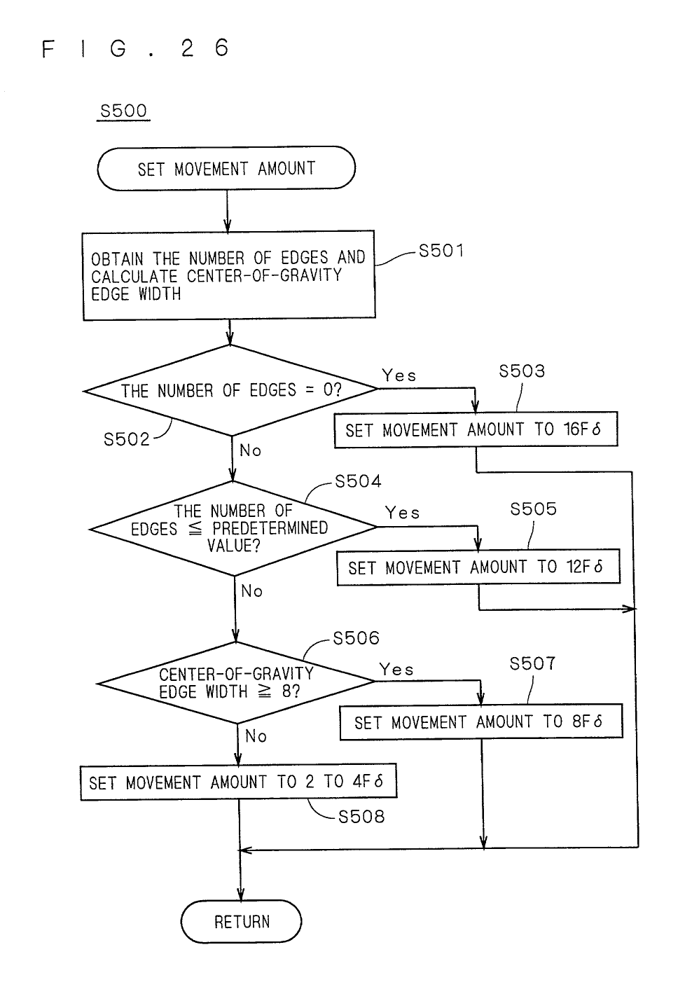

FIGS. 24 and 25 are diagrams showing the flow of an AF control of the digital camera 1 in a second preferred embodiment. FIG. 26 is a diagram showing a part of the AF control. Since the structure of the digital camera 1 and the outline of the image capturing operation (FIG. 7) are similar to those of the first preferred embodiment, the AF control of the digital camera 1 according to the second preferred embodiment will be described hereinbelow by referring to FIGS. 24 to 26 and FIG. 9.

When the shutter button 8 is pressed halfway down and an instruction of preparation for image capturing is input to the overall control portion 211, the AE calculation (step S12 in FIG. 7) is executed and, further, the AF control (step S13) is performed. In the AF control, first, the driving direction (that is, moving direction) of the lens is determined by an operation shown in FIG. 24. After that, a lens moving control shown in FIG. 25 is performed. On determination of the lens driving direction, the movement amount of the lens is set (step S500). FIG. 26 is a diagram showing the flow of setting the lens movement amount.

In the setting of the movement amount, in a manner similar to the first preferred embodiment, edges in the AF area 401 are detected by the histogram generating circuit 251, and the number Ven of edges and the center-of-gravity edge width Vew are calculated as evaluation values by the histogram evaluating portion 264 (step S501). When the number Ven of edges is 0, the movement amount of the lens is set to 16 Fδ by the driving amount determining portion 265 (steps S502 and S503). When the number Ven of edges is equal to or smaller than a predetermined value (for example, 20), the movement amount is set to 12 Fδ (steps S504 and S505). When the center-of-gravity edge width Vew is 8 or wider, the movement amount is set to 8 Fδ (steps S506 and S507). When the center-of-gravity edge width Vew is less than 8, the lens is already close to the in-focus position. The movement amount is therefore set in a range from 2 to 4 Fδ (step S508).

After completion of setting of the movement amount, the lens is moved by a preset movement amount from the initial position in a direction to bring a nearer object into focus, and the contrast calculating circuit 252 calculates the contrast Vc1 (step S211 in FIG. 24). After that, the lens is moved only by the set movement amount in a direction to bring a farther object into focus (that is, returned to the initial position) where the contrast Vc2 is obtained. Further, the lens is moved only by the set movement amount in a direction to bring a farther object into focus, and the contrast Vc3 is obtained (steps S212 and S213).

The driving direction determining portion 266 checks whether the contrast Vc1, Vc2, and Vc3 satisfies the condition (Vc1>Vc2>Vc3) or not (step S214). When the condition is satisfied, the driving direction determining portion 266 determines the direction to bring a nearer object into focus as the driving direction. When the condition is not satisfied, the driving direction determining portion 266 determines the direction to bring a farther object into focus as the driving direction (steps S215 and S216).

After the driving direction is determined, the movement amount is set again by a similar method (step S500 in FIG. 25), under control of the control signal generating portion 268, the AF motor M2 is driven only by the movement amount set in step S500 in the determined driving direction, and the lens is moved (step S321). After that, the contrast Vc is calculated by the contrast calculating circuit 252 (step S322), and whether the contrast after the movement is lower than that before the movement or not is checked (step S323).

During the period in which the contrast is not lowered by the movement of the lens, step S500 and steps S321 and S322 are repeated (step S323). As the lens approaches the in-focus position, the movement amount to be set decreases. When the contrast Vc decreases from the preceding value, it is determined that the lens has passed the in-focus position. By performing interpolation by using the contrast Vc corresponding to a plurality of latest lens positions, the lens position at which the contrast Vc becomes the highest is obtained as an in-focus position. Further, while vibrating the lens, the contrast Vc is calculated, and the lens position is finely adjusted (step S324).

The AF control in the second preferred embodiment has been described above. In the second preferred embodiment, the movement amount of the lens at the time of determining the driving direction is set on the basis of edges detected from the AF area 401. That is, by using the evaluation value of focus derived from the edges, the movement amount necessary to determine the driving direction is set according to the degree of achieving focus. Consequently, the lens is not moved unnecessarily largely at the time of determining the driving direction, and the driving direction is determined promptly and properly.

At the time of moving the lens to the in-focus position, the movement amount is set on the basis of the evaluation value regarding edges and the evaluation value regarding contrast. Therefore, the more the lens is apart from the in-focus position, the higher the lens driving speed is set. Thus, the prompt and high-precision AF control is realized.

3. Third Preferred Embodiment

Although the driving amount (movement amount) of once of the focusing lens is obtained by using edges extracted from the AF area 401 in the foregoing first and second embodiments, the in-focus position can be also predicted by using two center-of-gravity edge widths. A basic method of predicting the in-focus position will be described first and, after that, an AF control according to a third preferred embodiment using the method will be described.

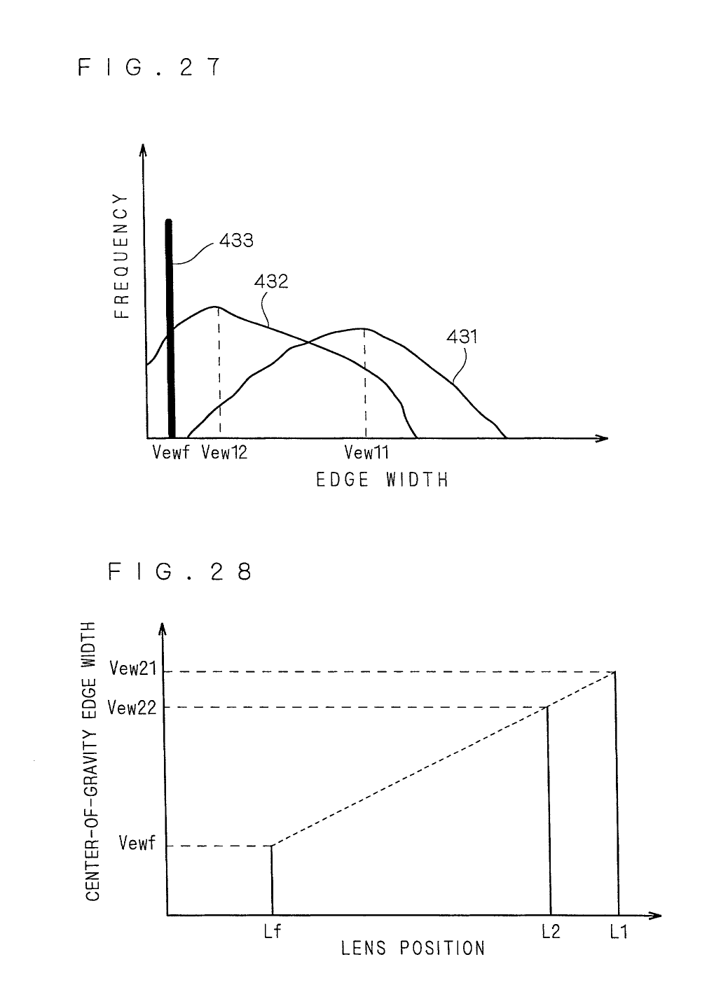

FIG. 27 is a diagram showing a state where a histogram of edge widths changes as the lens approaches the in-focus position. Reference numeral 431 denotes a histogram obtained in the case where the lens is largely apart from the in-focus position. Reference numeral 432 denotes a histogram in the case where the lens is closer to the in-focus position as compared with the case of the histogram 431. Reference numeral 433 indicates a histogram obtained in the case where the lens is in the in-focus position. Reference numerals Vew11, Vew12, and Vewf express center-of-gravity edge widths of the histograms 431, 432, and 433, respectively.

As shown in FIG. 27, the center-of-gravity edge width becomes narrower as the lens approaches the in-focus position. The narrowest center-of-gravity edge width Vewf slightly changes according to an MTF (Modulation Transfer Function which is an index value indicating reproducibility of contrast of an image at a spatial frequency of the optical system) of the optical system, image capturing condition, object, and the like. When a criteria of determining the focus is low, the narrowest center-of-gravity edge width Vewf in the case where the lens is positioned in the in-focus position can be regarded as a predetermined value and can be preliminarily obtained. In the following described, the narrowest center-of-gravity edge width Vewf will be called a “reference edge width”.

FIG. 28 is a diagram showing the relation between the lens position and the center-of-gravity edge width. The center-of-gravity edge widths corresponding to lens positions L1 and L2 are Vew21 and Vew22, respectively. The reference edge width corresponding to the in-focus position Lf is Vewf. As shown in FIG. 28, generally, it can be regarded that the lens position and the center-of-gravity edge width have a linear relation. Therefore, when the center-of-gravity edge widths Vew21 and Vew22 corresponding to the lens positions L1 and L2 are obtained, the in-focus position Lf can be derived by Equation 2 using the reference edge width Vwef.

$$Lf = L 1 - ( L 1 - L 2 ) \cdot \frac{Vew 21 - Vewf}{Vew 21 - Vew 22} \qquad [ Equation 2 ]$$

In place of the center-of-gravity edge width, a statistical value such as an average value of edge widths, an edge width corresponding to the peak of the histogram, or a median of edge widths can be used at the time of calculating the in-focus position.

In the method shown in FIG. 28, the in-focus position can be calculated by obtaining the center-of-gravity edge widths in at least two lens positions. In order to increase the precision, the precision of the center-of-gravity edge widths in the lens positions L1 and L2 may be increased by using the center-of-gravity edge widths in the positions (L1±aFδ) and (L2±aFδ) apart from the lens positions L1 and L2 each only by a predetermined distance aFδ. Concretely, when the center-of-gravity edge widths in the positions (L1−aFδ), L1, and (L1+aFδ) are Vew31, Vew32, and Vew33, respectively, a value Vew3 obtained by passing those values to a low-pass filter by Equation 3 is derived as a center-of-gravity edge width in the lens position L.

Vew3=(Vew31+2·Vew32+Vew33)/4 [Equation 3]

Similarly, when the center-of-gravity edge widths in the positions (L2−aFδ), L2, and (L2+aFδ) are Vew41, Vew42, and Vew43, respectively, a value Vew4 is derived as a center-of-gravity edge width in the lens position L2 by Equation 4.

Vew4=(Vew41+2−Vew42+Vew43)/4 [Equation 4]

Obviously, it is also possible to obtain center-of-gravity edge widths in three or more arbitrary lens positions and derive a straight line indicative of the relation between the lens position and the center-of-gravity edge width by using a least square method.

The flow of the AF control in the third preferred embodiment will now be described. The configuration and the basic operation (FIG. 7) of the digital camera 1 according to the third preferred embodiment are similar to those of the first preferred embodiment.

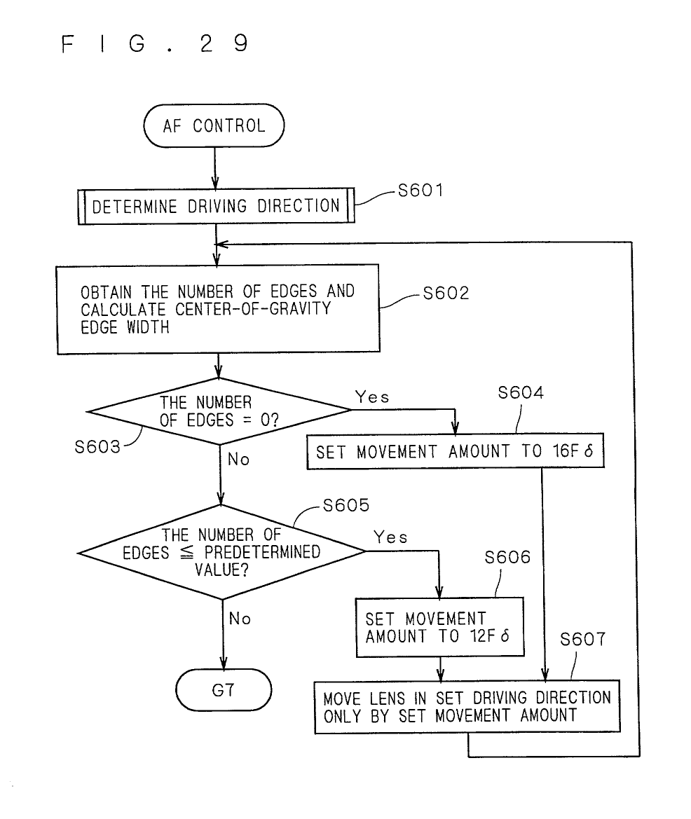

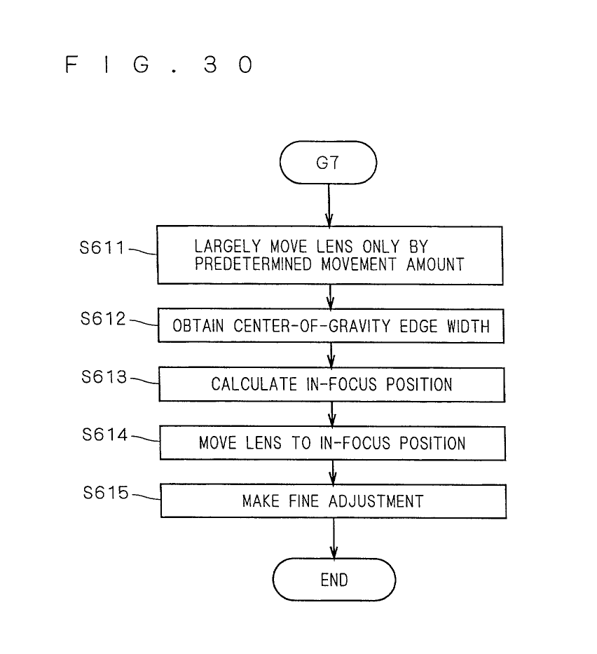

FIGS. 29 and 30 are diagrams showing a part of the flow of an AF control in the third preferred embodiment. In the autofocus, first, the driving direction of the lens is determined (step S601). The driving direction may be determined by either the method in the first preferred embodiment (steps S201 to S206 in FIG. 17) or the method in the second preferred embodiment (step S500 and steps S211 to S216 in FIG. 24).

After the driving direction is determined, in a state where the lens exists in the initial position, the number Ven of edges and the center-of-gravity edge width Vew are calculated by the histogram evaluating portion 264 (step S602). Subsequently, by the driving amount determining portion 265, when the number Ven of edges is 0, the driving amount (the movement amount of the lens) is set to 16 Fδ (steps S603 and S604). When the number Ven of edges is not 0 but is equal to or smaller than a predetermined value (for example, 20), the movement amount of the lens is set to 12 Fδ (steps S605 and S606).

When step S604 or S606 is executed, the lens is moved in the set driving direction by the set movement amount (step S607), and the process returns to step S602. By repeating the setting of the movement amount, movement of the lens, and calculation of the number Ven of edges and the center-of-gravity edge width Vew, the lens is moved to the lens position at which the number Ven of edges exceeds the predetermined value (hereinbelow, called “position L1”).

When the lens reaches the position L1, the center-of-gravity edge width Vew21 in the position L1 is stored. After that, the lens is driven so as to be largely moved in the driving direction set in step S601 by the preset movement amount (step S611 in FIG. 30). In the position after the movement (hereinbelow, called “position L2”), the center-of-gravity edge width Vew22 is computed again (step S612).

After that, arithmetic operation of Equation 2 is executed and an approximate focus position is calculated (step S613). That is, the in-focus position is estimated. The lens is promptly moved to the calculated focus position (step S614), and fine adjustment is carried out so that the position of the lens accurately coincides with the in-focus position while obtaining the contrast Vc (step S615).

As described above, in the AF control in the third preferred embodiment, the center-of-gravity edge widths are obtained in the first and second positions L1 and L2, and the in-focus position is estimated. Therefore, the lens can be promptly moved to the in-focus position. Since both the lens moving operation using the center-of-gravity edge width and the lens moving operation using the contrast are used, the lens can be positioned to the in-focus position with accuracy.

In the third preferred embodiment, the lens is preliminarily moved to the position L1 at which the number of edges exceeds the predetermined value and the lens is moved in the predetermined driving direction, that is, the direction to the in-focus position and is positioned in the position L2. Thus, the in-focus position can be estimated properly.

Also in the third preferred embodiment, in place of the center-of-gravity edge width Vew, any of the other representative values of the histogram can be used as an evaluation value indicative of the degree of achieving focus.

Although the distance between the first and second positions L1 and L2 can be preset to a certain value, it may be changed according to the number Ven of edges in the position L1 or the center-of-gravity edge width Vew. That is, to properly estimate the in-focus position, the lower the degree of achieving focus indicated by any of the evaluation values is, the longer the distance between the positions L1 and L2 may be set.

4. Fourth Preferred Embodiment

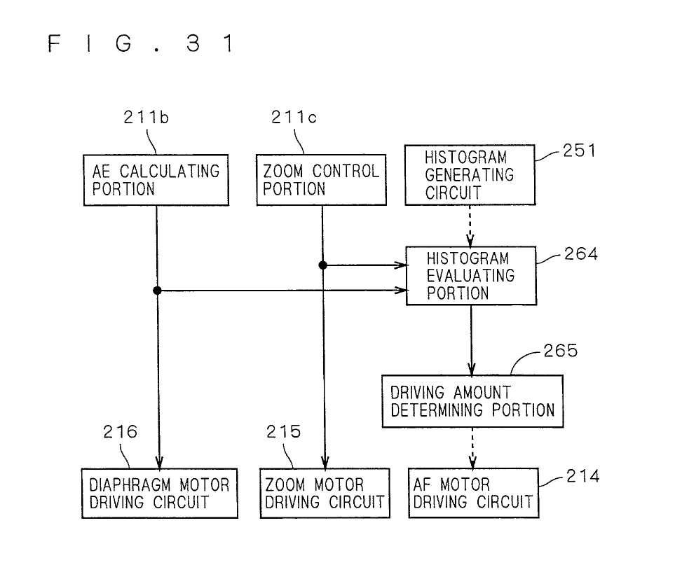

In the first to third preferred embodiments, the focusing lens is driven by using edges extracted from the AF area 401. However, when the optical system is a zoom lens or a lens is replaced, the characteristics of the optical system are changed. FIG. 31 is a block diagram showing the configuration of a case where the lens driving control is changed according to a change in the optical system.

In FIG. 31, the histogram generating circuit 251, histogram evaluating portion 264, and driving amount determining portion 265 correspond to those shown in FIG. 9. The AE calculating portion 211b and a zoom control portion 211c (not shown in FIG. 5) have the function of the overall control portion 211 for calculating the driving amounts of the diaphragm motor M3 and the zoom motor M1, respectively.

As described above, a black-level-corrected image is input to the AE calculating portion 211b, and exposure time and the aperture value (f-number) of the CCD 303 are computed. The aperture value (f-number) is input to the diaphragm motor driving circuit 216, and a drive signal to the diaphragm motor M3 is generated. On the other hand, the aperture value (f-number) is also input to the histogram evaluating portion 264.

In the zoom control portion 211c, a signal for controlling zoom is generated according to the operation of the user and is supplied to the zoom motor driving circuit 215 by which a drive signal to the zoom motor M1 is generated. The signal for controlling zoom is also input to the histogram evaluating portion 264.

In the case of forming the configuration shown in FIG. 31 in the first and second preferred embodiments, various threshold values used at the time of detecting edges are changed. Concretely, threshold values Th1 and Th2 shown in FIG. 10 are changed. Further, a threshold value Th3 used for eliminating noise and width E1 for extracting edges of a main object shown in FIG. 22 may be also changed. On the other hand, in the case of forming the configuration shown in FIG. 31 in the third preferred embodiment, the reference edge width Vewf is changed. That is, various parameters at the time of calculating an evaluation value are changed and an evaluation value to be derived is changed.

The threshold values and the reference edge width are changed on the basis of the MTF indicative of contrast reproducibility of the optical system.

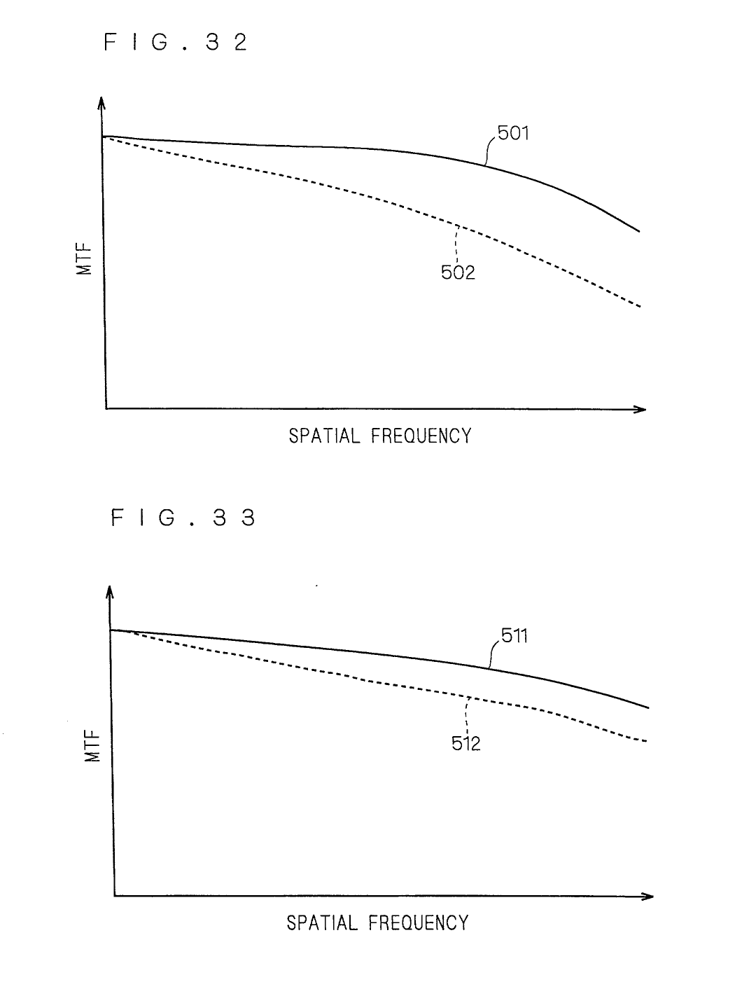

FIG. 32 is a diagram showing the relation between the aperture value (f-number) of the optical system and the MTF at image height of 0. In FIG. 32, a curve 501 illustrates MTF in the case where the f-number is 11 and a curve 502 illustrates MTF in the case where the f-number is 2.8. As shown in FIG. 32, generally, as the f-number increases, the MTF also increases.

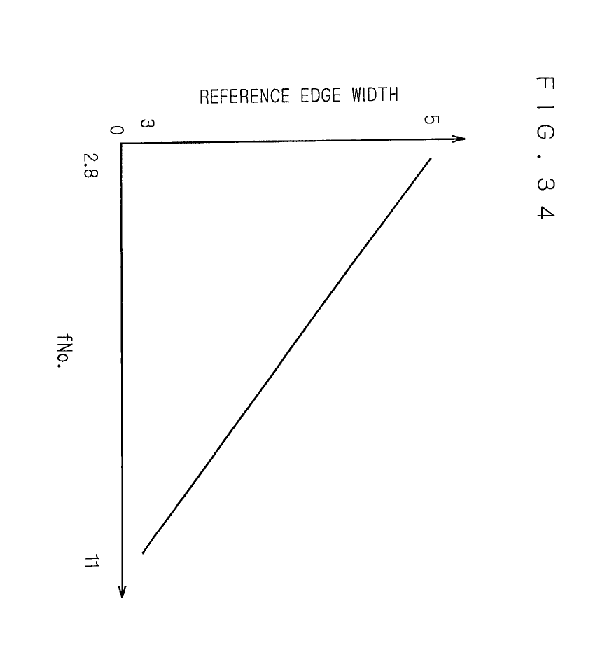

FIG. 33 is a diagram showing the relation between focal length of the optical system and the MTF at image height of 0. FIG. 33 shows the MTF of the case where the curves 511 and 512 have focal length which are different from each other. Although the focal length and the MTF do not have physical correlation, as shown in FIG. 33, when the focal length is changed, the MTF changes.

FIG. 34 is a diagram illustrating a state where the reference edge width in the third preferred embodiment is changed by the histogram evaluating portion 264 in accordance with a change in the f-number, that is, an aperture value. As shown in FIG. 34, when the f-number is changed from 2.8 to 11, the reference edge width is changed from 5 (pixels) to 3.

As described above, the MTF characteristic of the optical system changes when the f-number or the focal length is changed. Since the f-number changes according to the operation of the diaphragm and the focal length is changed by zooming, in the fourth preferred embodiment, when outputs of the AE calculating portion 211b and the zoom control portion 211c are input to the histogram evaluating portion 264 and the aperture value (f-number) of the optical system or the focal length is changed, the evaluation values (the number Ven of edges and the center-of-gravity edge width Vew) obtained by the histogram evaluating portion 264 and the reference edge width Vewf used in the histogram evaluating portion 264 are changed. By the operation, the proper AF control according to the change in the spatial frequency characteristic of the optical system is realized.

Obviously, the characteristics of the optical system change also by replacement of the lens or attachment of a filter (such as a filter for soft focusing). In this case, characteristics of a plurality of kinds of replacement lenses and filters are prepared in the histogram evaluating portion 264 and, by changing the threshold value and the reference edge width in accordance with the replacement of the lens or the attachment of the filter, proper AF control is realized.

5. Modifications

Although the preferred embodiments according to the present invention have been described above, the present invention is not limited to the preferred embodiments but can be variously modified.

For example, in the preferred embodiments, the image pickup potion 3 having the optical system and the camera body portion 2 for controlling the optical system can be separated from each other, and the camera body portion 2 serves as a controller for the optical system. A digital camera integrally having the optical system and the control system may be also used. A configuration in which the optical system and the control apparatus are connected by using a cable may be used. In this case, a general computer may be used as the control apparatus. In the computer, a program for controlling the optical system is pre-installed via a recording medium such as an optical disk, magnetic disk, or magnetooptic disk.

Preparation for image capture may be instructed to the AF control portion 211a by a configuration other than the shutter button 8. For example, a sensor for sensing that one of the eyes of the user approaches the finder 31 or sensing that the grip portion 4 is gripped may send a signal for instructing the image capturing preparation to the AF control portion 211a. The preparation for image capture may be also instructed by a signal generated by operating a button other than the shutter button 8 or a signal from a self timer or a timer used at the time of interval image capture. As described above, as long as the time just before image capture can be notified to the AF control portion 211a, various configurations can be used as configurations for instructing preparation for image capture.

In the embodiments, as shown in FIG. 8, it is described that the processes in the AF control portion 211a are divided into the process by the dedicated circuits and the processes performed in a software manner by the CPU for the sake of convenience. However, the description implies that all the processes is executed by the CPU. In this case, by executing the program by the CPU, all the AF control described in the foregoing preferred embodiments is executed. On the contrary, the description implies that all the processes in the AF control portion 211a is realized by dedicated circuits.

The edge detecting process in the preferred embodiments is just an example. Edges may be detected by other methods. Although the edges are detected only in the horizontal direction in the foregoing preferred embodiments, the edges may be detected in the vertical direction or both horizontal and vertical directions.

Although the contrast is used as it is as an evaluation value in the preferred embodiments, the evaluation value may be derived by converting the contrast. Specifically, in the foregoing preferred embodiments, the process for calculating contrast by the contrast calculating circuit 252 and the process of obtaining the evaluation value from the contrast are performed substantially as a single process. However, the processes may exist as separate processes, and circuits may be separated for the processes. Using the contrast as it is as an evaluation value is just an example of the process for calculating the contrast and obtaining the evaluation value.

In the first preferred embodiment, the contrast is used as an evaluation value to determine the driving direction of the lens. In the second preferred embodiment, by using the contrast and the center-of-gravity edge width (or the number of edges), the lens driving direction is determined. However, by using the center-of-gravity edge width in place of the contrast, the lens driving direction can be also determined. In this case, the lens driving direction is determined without using the contrast.

Similarly, also at the time of accurately positioning the lens into the in-focus position, in place of the contrast, the center-of-gravity edge width can be used.

Further, other values can be used as evaluation values regarding edges. For example, the frequency of edges each having a width of about 3 or 4 close to the reference edge width can be simply used as an evaluation value. The ratio of the frequency of edges in a predetermined edge width range including the reference edge width to all the frequencies can be also used as an evaluation value. In this case, the higher the frequency is, the higher the degree of achieving focus becomes.

Although the evaluation values in the three lens positions are obtained at the time of determining the lens driving direction in the preferred embodiments, the number of evaluation values may be two. The three evaluation values are used just to increase the precision in the determination of the driving direction. Also in the case where three or more evaluation values can be obtained, the driving direction is determined on the basis of the principle that, when viewed from a lens position with a low degree of focus indicated by one evaluation value, as a rule, the in-focus position exists in a direction toward a lens position with a higher degree of focus indicated by another evaluation value.

Since the AF control is performed by controlling the position of the focusing lens in the digital camera 1, the AF control has been described by using the words “lens position”. Also in the case of performing the AF control by driving a plurality of lenses, the AF control in the foregoing preferred embodiments can be also used. That is, the lens position in the preferred embodiments can be associated with arrangement of at least one lens.

Although the image signal is input from the black level correcting circuit 206 to the overall control portion 211 in order to obtain the evaluation value for autofocus in the digital camera 1, the image signal may be input from another portion to the overall control portion 211. The at least one lens for capturing images is not necessarily a zoom lens.

Since the high-speed AF control is realized by using edges, the foregoing preferred embodiments are particularly suitable for capturing a still image. However, various techniques in the preferred embodiments can be also applied to capturing of moving images.

With the configuration, the evaluation value is obtained from edges and the driving speed is changed on the basis of the evaluation value, so that the control related to focusing of the optical system can be performed promptly.

Since the histogram of edge widths is generated at the time of obtaining an evaluation value and the edge width corresponding to the center of gravity of the histogram as a statistical value obtained from the histogram is used, a proper evaluation value can be calculated.

The evaluation value is compared with the threshold value and the optical system is driven according to a result of the comparison. After that, the evaluation value is calculated again. Thus, the optical system can be promptly driven until the comparison result changes.

The optical system can be properly controlled by using both the evaluation value obtained from edges and the evaluation value obtained from the contrast.

By using the evaluation value calculated from the contrast, the driving direction can be determined properly. Further, by using also the evaluation value obtained from edges, the driving direction can be determined more properly.

The evaluation value obtained from edges can be used for determining the driving direction of the optical system and driving the optical system.

By eliminating noise components from the detected edges, a more proper evaluation value can be calculated.

Since the noise components include edges having an edge width of one pixel, the noise due to the high frequency component in an image can be eliminated.

By extracting a region where an edge width falls within a predetermined range from the histogram from which a noise component is not eliminated yet, the noise component is eliminated. Consequently, the region other than the main object in an image can be eliminated as noise components.

Since an edge having an edge width which is equal to or larger than a predetermined value is used at the time of calculating an evaluation value, the proper evaluation value is derived.

Since a region where the frequency is higher than a predetermined value in a histogram of various edge widths is used at the time of obtaining an evaluation value, a proper evaluation value is derived.

Since an amount of driving an optical system is changed according to characteristics of the optical system, the optical system can be controlled according to the characteristics of the optical system including a focal distance and an aperture value (f-number).

While the invention has been shown and described in detail, the foregoing description is in all aspects illustrative and not restrictive. It is therefore understood that numerous modifications and variations can be devised without departing from the scope of the invention.

What is claimed is:

1. An apparatus for controlling an optical system at the time of capturing a still image as digital data, comprising:
an instructing part for instructing preparation for image capturing;
a calculator for detecting edges in an image in response to an instruction from said instructing part and calculating an evaluation value indicative of the degree of achieving focus from said edges; and
a controller for driving said optical system while changing a driving speed on the basis of said evaluation value.

2. The apparatus according to claim 1, wherein said evaluation value is obtained on the basis of a histogram of widths of said edges.

3. The apparatus according to claim 2, wherein said evaluation value includes a statistical value obtained from said histogram.

4. The apparatus according to claim 3, wherein said evaluation value includes an edge width corresponding to a center of gravity of said histogram.

5. The apparatus according to claim 1, wherein said evaluation value includes the number of said edges.

6. The apparatus according to claim 1, wherein said controller compares said evaluation value with a threshold value and changes said driving speed in accordance with a comparison result.

7. The apparatus according to claim 1, wherein said controller compares said evaluation value with a threshold value and, after said optical system is driven in accordance with a comparison result, said evaluation value is calculated again.

8. A method of controlling an optical system at the time of capturing a still image as digital data, comprising the steps of:
instructing preparation for image capturing;
detecting edges in an image in response to an instruction of said preparation for image capturing;
obtaining an evaluation value indicative of the degree of achieving focus from said edges; and
driving said optical system while changing a driving speed on the basis of said evaluation value.

9. A recording medium on which a program for making a controller control an optical system at the time of capturing a still image as digital data is recorded, wherein execution of said program by the controller makes said controller execute the steps of:
instructing preparation for image capturing;
detecting edges in an image in response to an instruction of said preparation for image capturing;
obtaining an evaluation value indicative of the degree of achieving focus from said edges; and
driving said optical system while changing a driving speed on the basis of said evaluation value.

10. An apparatus for controlling an optical system at the time of capturing a still image as digital data, comprising:
an instructing part for instructing preparation for image capturing;
a first calculator for detecting edges in an image and calculating a first evaluation value indicative of the degree of achieving focus from said edges;
a second calculator for calculating contrast of said image and obtaining a second evaluation value indicative of the degree of achieving focus from said contrast; and
a controller for driving said optical system on the basis of said first and second evaluation values in response to an instruction of said preparation for image capturing,
wherein said controller determines a driving direction of said optical system by using said second evaluation value and calculates a driving amount of said optical system by using said first evaluation value.

11. The apparatus according to claim 10, wherein said controller calculates said second evaluation value in first arrangement and second arrangement of said optical system to determine said driving direction such that a degree of achieving focus increases along said driving direction between said first and second arrangement of said optical system.

12. The apparatus according to claim 11, wherein said controller determines the driving amount between said first and second arrangements on the basis of said first evaluation value in said first arrangement.

13. The apparatus according to claim 10, wherein said first evaluation value is calculated on the basis of widths of said edges.

14. The apparatus according to claim 13, wherein said first evaluation value includes an edge width corresponding to a center of gravity of a histogram of widths of said edges.

15. A method of controlling an optical system at the time of capturing a still image as digital data, comprising the steps of:
instructing preparation for image capturing;
detecting edges in an image in response to an instruction of said preparation for image capturing;
obtaining a first evaluation value indicative of the degree of achieving focus from said edges;
obtaining contrast of said image;
obtaining a second evaluation value indicative of the degree of achieving focus from said contrast;
determining a driving direction of said optical system by using said second evaluation value; and
obtaining a driving amount of said optical system by using said first evaluation value.

16. A recording medium on which a program for making a controller control an optical system at the time of capturing a still image as digital data is recorded, wherein execution of said program by the controller makes said controller execute the step of:
instructing preparation for image capturing;
detecting edges in an image in response to an instruction of said preparation for image capturing;
obtaining a first evaluation value indicative of the degree of achieving focus from said edges
obtaining contrast of said image;
obtaining a second evaluation value indicative of the degree of achieving focus from said contrast;
determining a driving direction of said optical system by using said second evaluation value; and
obtaining a driving amount of said optical system by using said first evaluation value.

17. An apparatus for controlling an optical system at the time of capturing a still image as digital data, comprising:
an instructing part for instructing preparation for image capturing;
a calculator for detecting edges in an image in response to an instruction of said preparation for image capturing and calculating an evaluation value indicative of the degree of achieving focus from said edges; and
a controller for determining a driving direction of said optical system and driving said optical system on the basis of said evaluation value.

18. The apparatus according to claim 17, wherein said controller calculates said evaluation value in first arrangement and second arrangement of said optical system to determine said driving direction such that a degree of achieving focus increases along said driving direction between said first and second arrangement of said optical system.

19. The apparatus according to claim 18, wherein said controller determines the driving amount between said first and second arrangements on the basis of said evaluation value in said first arrangement.

20. A method of controlling an optical system at the time of capturing a still image as digital data, comprising the steps of:
instructing preparation for image capturing;
detecting edges in an image in response to an instruction of said preparation for image capturing;
obtaining an evaluation value indicative of the degree of achieving focus from said edges;
determining a driving direction of said optical system by using said evaluation value; and
driving said optical system on the basis of said evaluation value.

21. A recording medium on which a program for making a controller control an optical system at the time of capturing a still image as digital data is recorded, wherein execution of said program by the controller makes said controller execute the steps of:
instructing preparation for image capturing;
detecting edges in an image in response to an instruction of said preparation for image capturing;
obtaining an evaluation value indicative of the degree of achieving focus from said edges;
determining a driving direction of said optical system by using said evaluation value; and
driving said optical system by using said evaluation value.

22. An apparatus for controlling an optical system at the time of capturing an image as digital data, comprising:
a detector for detecting edges in an image;
a noise eliminating part for eliminating noise components derived from noises from said edges;
a calculator for calculating an evaluation value indicative of the degree of achieving focus from the edges from which the noise components have been eliminated; and
a controller for driving said optical system on the basis of said evaluation value.

23. The apparatus according to claim 22, wherein said noise component includes edges having an edge width of one pixel.

24. The apparatus according to claim 22, wherein said evaluation value is calculated on the basis of a histogram of widths of the edges from which the noise components have been eliminated.

25. The apparatus according to claim 24, wherein said evaluation value includes a statistical value obtained from said histogram.

26. The apparatus according to claim 24, wherein said noise component is eliminated by extracting a region where an edge width falls within a predetermined range from the histogram which has not been subjected to noise component elimination yet.

27. The apparatus according to claim 24, wherein said evaluation value includes an edge width corresponding to a center of gravity of the histogram already subjected to the noise component elimination.

28. A method of controlling an optical system at the time of capturing an image as digital data, comprising the steps of:
detecting edges in an image;
eliminating noise components derived from noises from said edges;
calculating an evaluation value indicative of the degree of achieving focus from the edges from which the noise components have been eliminated; and
driving said optical system on the basis of said evaluation value.

29. A recording medium on which a program for making a controller control an optical system at the time of capturing a still image as digital data is recorded, wherein execution of said program by the controller makes said controller execute the steps of:
detecting edges in an image;
eliminating a noise component derived from noise from said edges;
calculating an evaluation value indicative of the degree of achieving focus from the edges from which the noise components have been eliminated; and
driving said optical system on the basis of said evaluation value.

30. An apparatus for controlling an optical system at the time of capturing an image as digital data, comprising:
a detector for detecting edges in an image;
a calculator for calculating an evaluation value indicative of the degree of achieving focus from edges each having an edge width which is equal to or larger than a predetermined value; and
a controller for driving said optical system on the basis of said evaluation value.

31. A method of controlling an optical system at the time of capturing an image as digital data, comprising the steps of:
detecting edges in an image;
calculating an evaluation value indicative of the degree of achieving focus from edges each having an edge width which is equal to or larger than a predetermined value; and
driving said optical system on the basis of said evaluation value.

32. A recording medium on which a program for making a controller control an optical system at the time of capturing a still image as digital data is recorded, wherein execution of said program by the controller makes said controller execute the steps of:
detecting edges in an image;
calculating an evaluation value indicative of the degree of achieving focus from edges each having an edge width which is equal to or larger than a predetermined value; and
driving said optical system on the basis of said evaluation value.

33. An apparatus for controlling an optical system at the time of capturing an image as digital data, comprising:
a detector for detecting edges in an image;
a calculator for calculating an evaluation value indicative of the degree of achieving focus from said edges; and
a controller for driving said optical system on the basis of said evaluation value,
wherein said calculator calculates a histogram of the widths of said edges, and obtains, as said evaluation value, a representative value of a region where the frequency is higher than a predetermined value in said histogram.

34. The apparatus according to claim 33, wherein said evaluation value includes an edge width corresponding to a center of gravity of said region where the frequency is higher than the predetermined value in said histogram.

35. A method of controlling an optical system at the time of capturing an image as digital data, comprising the steps of:
detecting edges in an image;
obtaining a histogram of widths of said edges;
calculating a representative value of a region where the frequency is higher than a predetermined value in said histogram, as an evaluation value indicative of the degree of achieving focus; and
driving said optical system on the basis of said evaluation value.

36. A recording medium on which a program for making a controller control an optical system at the time of capturing a still image as digital data is recorded, wherein execution of said program by the controller makes said controller execute the steps of:
detecting edges in an image;
obtaining a histogram of widths of said edges;
calculating a representative value of a region where the frequency is higher than a predetermined value in said histogram, as an evaluation value indicative of the degree of achieving focus; and
driving said optical system on the basis of said evaluation value.

37. An apparatus for controlling an optical system at the time of capturing an image as digital data, comprising:
a detector for detecting edges in an image;
a calculator for obtaining an evaluation value indicative of the degree of achieving focus from said edges; and
a controller for obtaining a driving amount of said optical system on the basis of said evaluation value,
wherein said driving amount is changed according to characteristics of said optical system.

38. The apparatus according to claim 37, wherein the characteristics of said optical system include a focal length.

39. The apparatus according to claim 37, wherein the characteristics of said optical system includes an aperture value.

40. The apparatus according to claim 37, wherein said evaluation value is obtained on the basis of the histogram of widths of said edges.

41. The apparatus according to claim 40, wherein said evaluation value includes a statistical value obtained from said histogram.

42. The apparatus according to claim 41, wherein said evaluation value includes an edge width corresponding to a center of gravity of said histogram.

43. A method of controlling an optical system at the time of capturing an image as digital data, comprising the steps of:
detecting edges in an image;
obtaining an evaluation value indicative of the degree of achieving focus from said edges; and
obtaining a driving amount of driving said optical system on the basis of said evaluation value,
wherein said driving amount is changed according to the characteristics of said optical system.

44. A recording medium on which a program for making a controller control an optical system at the time of capturing a still image as digital data is recorded, wherein execution of said program by the controller makes said controller execute the steps of:
detecting edges in an image;
obtaining an evaluation value indicative of the degree of achieving focus from said edges; and
obtaining the driving amount of said optical system on the basis of said evaluation value,
wherein said driving amount is changed according to the characteristics of said optical system.
